(19) United States
(12) Patent Application Publication
(10) Pub. No.: US 2016/0313874 A1
(43) Pub. Date: Oct. 27, 2016

(54) VISUAL EFFECTS SYSTEM FOR "BIG DATA" ANALYSIS WORKFLOW EDITORS, DISTRIBUTION PLATFORMS, EXECUTION ENGINES, AND MANAGEMENT SYSTEMS COMPRISING SAME

(71) Applicant: Biodatomics, LLC, Bethesda, MD (US)

(72) Inventor: Maxim Mikheev, Elkridge, MD (US)

(21) Appl. No.: 15/102,026

(22) PCT Filed: Dec. 6, 2014
(86) PCT No.: PCT/US14/68963

§ 371 Date: Jun. 6, 2016

Related U.S. Application Data
(63) Continuation of application No. 14/099,789, filed on Dec. 6, 2013.
Application No. 14/099,789 is a continuation of application No. 14/099,864, filed on Dec. 6, 2013, now abandoned.
Application No. 14/099,864 is a continuation of application No. 14/099,884, filed on Dec. 6, 2013, now abandoned.

(51) Int. Cl. G06F 3/0482; G06F 9/48; G06F 17/30

(52) U.S. Cl. CPC G06F 3/0482; G06F 17/30569; G06F 17/30592; G06F 17/30572; G06F 9/485

(57) ABSTRACT

Provided are methods and systems for the visualization, distribution, and event-driven management of elements of a workflow that defines an analysis of very large data sets using multi-node compute clusters. A method for visualization of elements of such a workflow may include displaying the workflow via a user interface, collapsing groups of elements, adding further elements, removing elements, and modifying elements in the workflow. A digital workflow distribution platform comprises a user interface configured to allow a user to select a workflow, to acquire the workflow, to import the workflow into a user environment, and to develop the workflow imported into the user environment. An event-driven management engine for workflows may activate one or more computational modules in response to triggering events wherein the computational modules may be allocated non-sequentially in a distributed cloud computing environment to process a data set according to predetermined criteria.

### TECHNICAL FIELD

This disclosure relates generally to data processing and, more specifically, to visualization, distribution platforms, and event-driven management of workflows that define data analysis when large datasets are involved (“Big Data”).

### BACKGROUND

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

A traditional workflow management system can manage and define a series of tasks within a project to produce a final result workflow management systems can allow defining different workflows for different types of tasks or processes. Furthermore, workflow management systems can assist a user in development of complex applications at a higher level by orchestrating functional components without handling the implementation details. At each stage in the workflow, one or more executable software modules may be responsible for a specific task. Once the task is complete, the workflow software can ensure that the next task is executed by the modules responsible for the next stage of the process. The workflow management system can reflect the dependencies required for the completion of each task. In general, the workflow management system can control automated processes by automating redundant tasks and ensuring that uncompleted tasks are followed up on.

The workflow management system can be developed in a specialized form for specific needs. Specifically, a scientific workflow management system can be designed to compose and execute a series of computational and data processing operations for a scientific application. An example of a scientific workflow management system is a bioinformatics workflow management system. Bioinformatics can be defined as an interdisciplinary field that develops and improves on methods for storing, retrieving, organizing and analyzing biological data. A major activity in bioinformatics is to develop software tools to generate useful biological knowledge. However, it should be understood that applications of the technology disclosed here are not necessarily limited to bioinformatics.

Since scientific workflows may differ from traditional business process workflows, the scientific workflow management system can enable scientists to perform specific steps. For example, interactive tools can be provided to enable scientists to execute scientific workflows and to view results interactively. Additionally, scientists may be able to track the source of the scientific workflow execution results and the steps used to create the workflow.

The need to extract insights from the ever-increasing data set sizes associated with Big Data analysis is leading to more and more complex workflows to manage. Consequently, visualization of such workflows in the workflow management systems becomes correspondingly complex, often obstructing visual perception and editability of the workflow for a workflow developer. As a result, developing and editing workflows by workflow developers can be time and effort consuming A workflow with a default set of tools can be purchased from a developer of the workflow. However, adding tools developed by other developers or modifying the default tools may not be possible because of the compatibility and other issues. Furthermore, available workflows and workflow engines are restricted to specific types of applications and their adaptation for a range of other specific purposes can be difficult. In addition, available workflow engines are usually configured as directed acyclic graphs. In a directed acyclic graph, each node represents a task to be executed and edges represent either data flow or execution dependencies between different tasks. Thus, sequences of data may only flow in a specific direction and may not allow for parallel execution of computational units.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

The present disclosure is related to approaches for visualization of elements of a workflow that defines an analysis of very large data sets using multi-node compute clusters. Specifically, a method for visualization of elements of a workflow comprises displaying the workflow via a graphical user interface (GUI) on a computer terminal. Based on predetermined grouping criteria, one or more collapsible groups of elements are defined within the workflow. Upon receiving a request to collapse the collapsible groups of elements, the collapsible groups of elements are collapsed into collapsed groups of elements. After the collapsing, a layout of the plurality of elements and the collapsed groups of elements can be selectively readjusted. The method further comprises adding further elements to the workflow, removing elements from the workflow, and modifying elements in the workflow.

According to another approach of the present disclosure, there is provided a system for visualization of elements of a workflow that defines an analysis of very large data sets using multi-node compute clusters. The system comprises a processor configured to define collapsible groups of elements within the workflow. The defining can be made based on predetermined grouping criteria. Upon receiving from a user a request to collapse the collapsible groups of elements, the processor can collapse the collapsible groups of elements into collapsed groups of elements. The processor is further configured to selectively readjust a layout of the plurality of elements and the collapsed groups of elements. The system further comprises a user interface configured to display the workflow that includes a plurality of elements.

The present disclosure is further related to approaches for distribution of a workflow that defines an analysis of very large data sets using multi-node compute clusters. Specifically, a digital workflow distribution platform comprises a user interface configured to allow a user to select a workflow based on one or more parameters associated with the workflow. Based on the selection, a distribution module enables the user to acquire the workflow and import the workflow into a user environment. The digital workflow distribution platform further comprises a management engine for workflow configured to support development of the workflow and workflow tools imported into the user environment. While prior art may include workflow distributions, it does not include subsequently modifiable workflows.

According to another approach of the present disclosure, there is provided a computer-implemented method for distribution of a workflow that defines an analysis of very large data sets using multi-node compute clusters. According to the method, a user interface receives a user command to select a workflow based on one or more parameters associated with the workflow. In response to the user command, the user is enabled to acquire the workflow and to import the workflow into a user environment. After the import of the workflow, development of the workflow can be supported by a management engine for workflows.

The present disclosure is further related to approaches for computer-implemented event-driven management of workflows that defines an analysis of very large data sets using multi-node compute clusters. Specifically, an event-driven management engine for such workflows may comprise a decision node configured to determine that a condition is true by running a conditional loop. Based on the determination, the decision node may selectively activate a computational module. The event-driven management engine for such workflows may further comprise a fork join queuing cluster. The fork join queuing cluster may allocate the computational module non-sequentially to participant computational nodes and process a data set according to predetermined criteria. The participant computational nodes may be located in a distributed cloud computing environment. A distributed database of the event-driven management engine for workflows that define an analysis of very large data sets using multi-node compute clusters may store the computational modules and conditions associated with the computational modules. A computation module may remain inactivated until the condition is true.

According to another approach of the present disclosure, there is provided a computer-implemented event-driven management method for workflows that define an analysis of very large data sets using multi-node compute clusters. According to the method, a database may store computational modules and conditions associated with the computational modules. The method may comprise a decision node running a conditional loop to determine that the condition is true. Based on the determination, the decision node may selectively activate the computational module. The method may further comprise allocating, by a fork-join queuing cluster, the computational module non-sequentially to participant computational nodes in a distributed cloud computing environment. The computational module may be configured to process a data set according to predetermined criteria.

In further example embodiments of the present disclosure, the method steps are stored on a machine-readable medium comprising instructions, which when implemented by one or more processors perform the recited steps. In yet further example embodiments, hardware systems or devices can be adapted to perform the recited steps. In yet a further example embodiment, the multi-node compute clusters is a Hadoop-based multi-node compute cluster. Other features, examples, and embodiments are described below.

### BRIEF DESCRIPTION OF THE DRAWINGS

Embodiments are illustrated by way of example, and not by limitation, in the figures of the accompanying drawings, in which like references indicate similar elements and in which:

FIG. 1 shows an environment within which an event-driven management engine for workflows that define an analysis of very large data sets using multi-node compute clusters and corresponding methods can be implemented, according to an example embodiment.

FIG. 2 is a block diagram showing various modules of an event-driven management engine for workflows that define an analysis of very large data sets using multi-node compute clusters, according to an example embodiment.

FIG. 3 is a block diagram illustrating processing of a task by an event-driven management engine for workflows that define an analysis of very large data sets using multi-node compute clusters, according to an example embodiment.

FIG. 4 is a block diagram illustrating processing of a task by a fork join queuing cluster, according to an example embodiment.

FIG. 5 is a block diagram illustrating processing of a task by a fork join queuing cluster, according to an example embodiment.

FIG. 6 is a process flow diagram showing an event-driven management method for workflows that define an analysis of very large data sets using multi-node compute clusters, according to an example embodiment.

FIG. 7 is a flow chart illustrating a detailed computer-implemented event-driven management method for workflows that define an analysis of very large data sets using multi-node compute clusters, according to an example embodiment.

FIG. 8 is a flow chart illustrating a method for checking a condition, according to an example embodiment.

FIG. 9 is flow chart illustrating a conditional loop, according to an example embodiment.

FIG. 10 is a flow chart illustrating a conditional loop, according to an example embodiment.

FIG. 11 shows an environment within which a platform for digital distribution of a workflow that defines an analysis of very large data sets using multi-node compute clusters and corresponding methods can be implemented, according to an example embodiment.

FIG. 12 is a block diagram showing various modules of a distribution platform for a digital workflow that defines an analysis of very large data sets using multi-node compute clusters, according to an example embodiment.

FIG. 13 is a scheme illustrating a method for distribution of a workflow that defines an analysis of very large data sets using multi-node compute clusters, according to an example embodiment.

FIG. 14 is a scheme illustrating a method for distribution of tools for a workflow that defines an analysis of very large data sets using multi-node compute clusters, according to an example embodiment.

FIG. 15 is a process flow diagram showing a computer-implemented method for distribution of a workflow that defines an analysis of very large data sets using multi-node compute clusters, according to an example embodiment.

FIG. 16 shows an environment within which a system for visualization of elements of a workflow that defines an analysis of very large data sets using multi-node compute clusters and associated methods can be implemented, according to example embodiments.

FIG. 17 is a process flow diagram showing a method for visualization of elements of a workflow that defines an analysis of very large data sets using multi-node compute clusters, according to an example embodiment.

FIG. 18 is a block diagram showing various modules of a system for visualization of elements of a workflow that defines an analysis of very large data sets using multi-node compute clusters, according to an example embodiment.

FIG. 19 is a block diagram illustrating a collapsed workflow that defines an analysis of very large data sets using multi-node compute clusters, according to an example embodiment.

FIG. 20 is a block diagram illustrating a partially collapsed workflow that defines an analysis of very large data sets using multi-node compute clusters, according to an example embodiment.

FIG. 21 is a scheme illustrating a partially collapsed workflow that defines an analysis of very large data sets using multi-node compute clusters, according to an example embodiment.

FIGS. 22A-C illustrate an expanded workflow that defines an analysis of very large data sets using multi-node compute clusters, according to an example embodiment.

FIG. 23 shows a diagrammatic representation of a computing cluster for a machine in the example electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The techniques of the embodiments disclosed herein are implemented using technologies associated with Big Data analyses. Specifically, the use of multi-node compute clusters is a preferred embodiment. More specifically, the use of the open-source Hadoop software ecosystem for management of large-scale multi-node compute clusters is a preferred embodiment. The present disclosure relates to systems and methods for providing workflow editors with improved visualization and for improving the usability by developers of workflows that define an analysis of very large data sets using multi-node compute clusters. Specifically, embodiments described herein include methods for the visualization of elements of such workflows. An example workflow can include multiple elements. The elements can include loops, conditional statements, markers, algorithms, nested workflows, tools, such as computational tools, and so forth. The elements of the workflow can be represented in a layout of the workflow. The layout can have a specific arrangement, sizing, spacing, and placement of the elements of the workflow shown on a user interface. In case of a complex management system for workflows with a great number of elements, it may be difficult for a user, e.g. a workflow developer, to see the functionality of each element. The method disclosed herein can provide improved editability of the workflow over methods known in the art. The method disclosed herein can enable adding new elements to the layout, connecting elements together, removing elements, hiding elements, reordering the elements automatically, and so forth. The method disclosed here can be implemented by an event-driven management engine which can enable, for example, scientists in the field of biology, bionomics and bioinformatics, to more efficiently than possible with prior art methods to query and analyze large genetic data sets using a number of informatics tools and to save results.

According to the present disclosure, elements of the layout can be ordered into groups. These groups can be collapsed into a single element representing the group. Similarly, the collapsed group can be expanded to show the constituent elements. Furthermore, the user can be allowed to connect several elements in the layout of the workflow to define a collapsible group. The group can be increased in size to show which elements are included in the group. When a user needs to access a particular element of the group, the user can expand the combined element and select the specific element.

Furthermore, in an example embodiment, the user can use markers for some elements of the workflow. The user can arrange several elements into a block and mark the block with the markers. The marked block can be smaller compared to the initial size of the block. In an example embodiment, the marker can show that the marked element is in a collapsed state and can be expanded, that the block is removed from the layout, and so forth. Furthermore, the user may provide a name for the block or mark the block with a symbol. The name can describe the elements included in the block. When the user needs to use a particular element hidden in a collapsed block, the user can get information on the collapsed block by reading the name, and if needed, expand the block. After expanding the block, all elements of the block can be shown and the user can select specific elements. Furthermore, where several elements of the workflow can be used in a similar way, the user can create algorithms to use these elements as a group. These elements can be connected into a single block and named according to their common functionality.

Furthermore, the workflow editor of the present disclosure provides for self-positioning of the elements in the layout to optimize the position of the elements in the layout for better visualization. Therefore, the elements may be positioned in the layout in such a way as to avoid unused portions of the layout between the elements of the workflow.

Collapsing and expanding the elements of the workflow can be especially helpful to demonstrate nested workflows. Nested workflows are workflows inside a main workflow. The nested workflows can include elements. A workflow can include any number of nested workflows, and each of the nested workflows, in turn, can include further nested workflows. A nested workflow can be collapsed or expanded within the main workflow. The nested workflow can be marked with a specific marker.

The present disclosure relates further to systems and methods for workflow distribution. Specifically, embodiments described herein include a digital workflow distribution platform and a computer-implemented method for workflow distribution. The digital workflow distribution platform described herein provides a virtual marketplace for workflows. The platform can be configured to distribute workflows for data analysis as well as to support various workflow tools. The digital workflow distribution platform enables scientists in the fields of science such as, for example, biology, bionomics, and bioinformatics, to more efficiently than is possible with prior art methods to query and analyze large genetic data sets using a number of informatics tools and to save the results.

In some example embodiments, a user can access the digital workflow distribution platform via a user interface and review available workflows. Upon selection of a workflow, the user can send a request for acquisition of the workflow to the digital workflow distribution platform. The digital workflow distribution platform can provide the workflow to the user as software as a service (SaaS). The workflow is hosted in a cloud environment.

Upon receiving the user request, the digital workflow distribution platform can import the selected workflow into the user environment. The user is provided with access to the user environment (for example, by registering with the platform). Upon authentication, the user is provided with access to the workflow and is able to perform various workflow operations. For example, the workflow can be used to manage computations of biological data.

The digital workflow distribution platform can allow users to develop the workflow imported into the user environment. In particular, the user is able to select and change parameters of the workflow, add, remove, and modify tools associated with the workflow, select conditions and order of execution, and so forth. An operator of the digital workflow distribution platform can be responsible for maintenance and support of the workflow development environment.

After importing the workflow into the user environment, the user may desire to acquire or develop additional workflow tools. The digital workflow distribution platform allows for development and operational supports of workflow tools. The platform can facilitate development of the tools using an Application Programming Interface (API) associated with the platform. The platform can also allow distribution of the tools to users as well as running the tools in a cloud computing environment. For example, a user can access the digital workflow distribution platform and select tools to be added to the workflow. The digital workflow distribution platform receives the user request and adds the selected tool to the workflow. After the tools are added, the user can utilize the tool in the workflow.

As mentioned above, the digital workflow distribution platform allows users to develop tools imported into the user environment. In particular, the user is able to add, create, or modify the tools of the workflow (e.g., by editing tool parameters).

The present disclosure still further relates to systems and methods for generating and implementing automated workflow activities. Specifically, embodiments described herein include an event-driven management engine for workflows and method. Conventional workflow engines create a process for each workflow that can determine a current state of the workflow and a next step to be executed. In other words, such workflow engines may need to permanently trace the current state of the workflow and make decisions as to what action should be taken next. Furthermore, the conventional workflow system may need control points to save the current state of the workflow in order to ensure a successful restart of the workflow in case of a failure. The event-driven management engine enables scientists in the fields of science such as, for example, biology, bionomics, and bioinformatics, to query and analyze large genetic data sets using a number of informatics tools and save the results.

As outlined in the summary, the embodiments of the present disclosure are directed to event-driven management for workflows. An event-driven workflow may be determined by events occurring in the workflow, such as a user action, a sensor output, notifications from other programs, and so forth. The disclosed technology may allow defining conditions associated with each event occurring in the workflow and storing the conditions in a database. Furthermore, the database may store steps and associated tasks to be performed upon satisfaction of the condition. Therefore, when the event occurs, the engine may read the database to confirm that the conditions associated with the event are satisfied and run a corresponding process to execute the task associated with the condition.

Specifically, a decision node may run a conditional loop that may check whether the condition is satisfied. Once the condition is satisfied, the decision node may activate the computational node responsible for processing the satisfied condition and execute the corresponding part of the workflow. Computational nodes responsible for processing may run only after the conditions are satisfied. Until the conditions are satisfied, the computational nodes may be in a waiting mode (i.e., inactivated).

It should be noted that in the case of an unexpected shutdown, the workflow may be easily restored by running conditional loops and determining which conditions are satisfied. After determining which conditions are satisfied, the tasks associated with the satisfied conditions may be restarted. Thus, there is no need to save control points to restart the workflow.

Furthermore, the present technology may be used in scientific workflow systems, such as bioinformatics workflow management systems, to manage computations performed on biological data, which are computationally intensive. To improve the efficiency, the present technology may involve data processing in a parallel-distributed software framework. The parallel-distributed software framework may support computationally-intensive distributed tasks by running tasks on a number of computational clusters in parallel. The parallel-distributed software framework may be Hadoop-based. The present technology may utilize fork-queuing nodes to split tasks between multiple computational clusters. Furthermore, the fork-queuing nodes may be configured to divide a task associated with the event into multiple task fragments, each of which can be executed in parallel with other fragments on any node of the cluster. The fork-queuing cluster may select the nodes for execution of these task fragments. The nodes may include cloud-based computational clusters. After execution of the fragments by the nodes, the fork-queuing cluster may join the executed fragments into resulting data.

The resulting data may be shown to a user on a user interface. The user may choose the way in which the processed data may be represented. For example, the processed data may be shown as data tables, diagrams, text, graphs, drawings, and so forth.

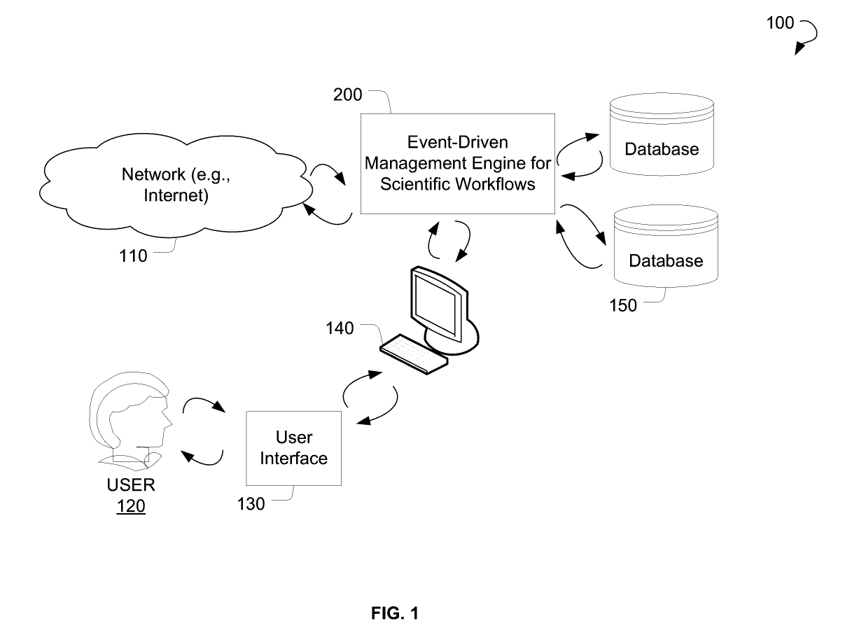

Referring now to the drawings, FIG. 1 illustrates a large-scale, computer cluster 100 within which an event-driven management engine for workflow that defines an analysis of very large data sets using multi-node compute clusters and method can be implemented. The environment 100 may include a network 110, a user 120, an event-driven management engine 200 for workflows, a user interface 130, one or more client devices 140, and a database 150.

The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 110 may include a network of data processing nodes that are interconnected for the purpose of data communication. The network 110 may include a Software-defined Networking (SDN). The SDN may include one or more of the above network types. Generally the network 110 may include a number of similar or dissimilar devices connected together by a transport medium enabling communication between the devices by using a predefined protocol. Those skilled in the art will recognize that the present disclosure may be practiced within a variety of network configuration environments and on a variety of computing devices.

The client device 140, in some example embodiments, may include a Graphical User Interface (GUI) for displaying the user interface 130. In a typical GUI, instead of offering only text menus or requiring typed commands, the engine 200 may present graphical icons, visual indicators, or special graphical elements called widgets. The user interface 130 may be utilized as a visual front-end to allow the user 120 to build and modify complex tasks with little or no programming expertise.

The client device 140 may include a mobile telephone, a computer, a lap top, a smart phone, a tablet Personal Computer (PC), and so forth. In some embodiments, the client device 140 may be associated with one or more users 120. The client device 140 may be configured to utilize icons used in conjunction with text, labels, or text navigation to fully represent the information and actions available to the user 120. The user 120, in some example embodiments, may be a person interacting with the user interface 130 via one of the client devices 140. The user 120 may represent a person that uses the event-driven management engine 200 for workflows for his or her needs. For example, the user 120 may include a scientist using the event-driven management engine 200 for scientific workflows for performing a series of intensive computational or data manipulation steps. As shown on FIG. 1, the user 120 may input data to an application running on the client device 140. The application may utilize the event-driven management engine 200 for workflows. Based on the input of the user 120, the event-driven management engine 200 for workflows may generate and execute the automated workflow of the application running on the client device 140. The event-driven management engine 200 for workflows may be connected to one or more databases 150. The databases 150 may store data associated with tasks that need to be executed in the course of the workflow.

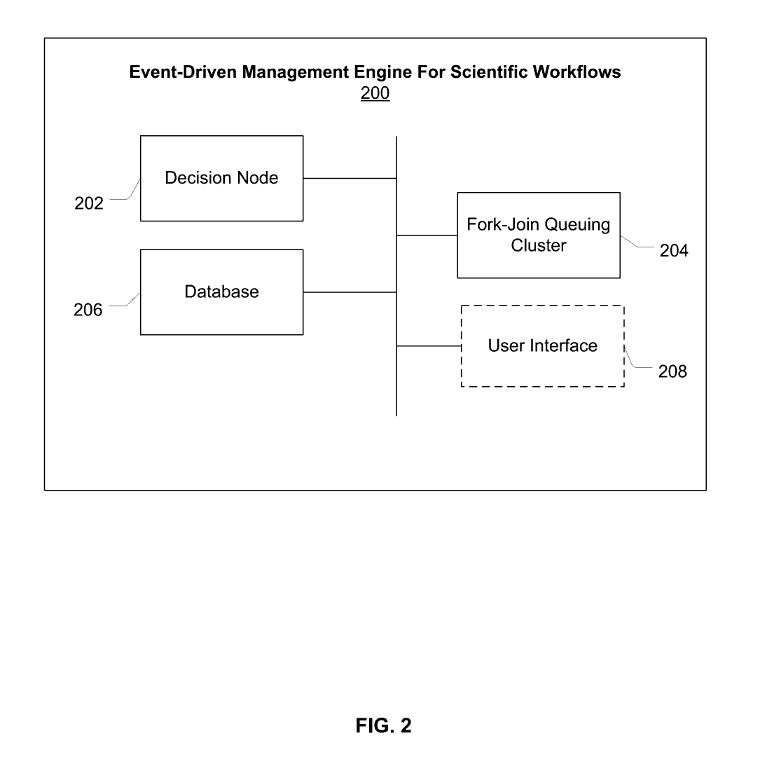

FIG. 2 shows a detailed block diagram of the event-driven management engine 200 for workflows that define an analysis of very large data sets using multi-node compute clusters, in accordance with an example embodiment. The engine 200 may include a decision node 202, a fork join queuing cluster 204, a database 206, and, optionally, a user interface 208.

The user may run an application that may utilize the event-driven management engine 200 for workflows. During running of the application, an event may occur. The event may include a user action, a sensor output, a notification from other programs, and so forth. Each event may be associated with one or more conditions that may be stored in the event-driven management engine 200 for workflows. The management engine 200 for workflows may include a decision node 202, a fork-join queuing cluster 204, a database 206, and, optionally, a user interface 208.

In an example embodiment, the decision node 202 may be configured to determine that the at least one condition is true. The determination that the at least one condition is true may be performed by running a conditional loop. The conditional loop may be configured to check whether the at least one condition is true.

The decision node 202 may be further configured to selectively activate, based on the determination, at least one computational module. The computational module may include a computational tool. The workflow may support a plurality of biological data formats and translations between the plurality of biological data formats. Therefore, the computational tool may refer to a specific field of science (for example, bioinformatics). In this case, the computational tool may include a bioinformatics tool enabling the user to process specific bioinformatics tasks.

After activation of the computational module, the fork-join queuing cluster 204 may allocate at least one computational module non-sequentially to participant computational nodes. The participant computational nodes may be located in a distributed cloud computing environment. By means of the participant computational nodes, the fork join queuing cluster 204 may process a data set according to predetermined criteria. The fork-join queuing cluster 204 enhances the speed and efficiency of the analysis of very large data sets using node-compute clusters.

The distributed database 206 may be configured to store at least one computational module. Furthermore, the distributed database 206 may be configured to store at least one condition associated with the at least one computational module. The user interface 208 may allow a user to build computational modules, modify computational modules, specify data sources, specify conditions for execution of the computational modules, etc.

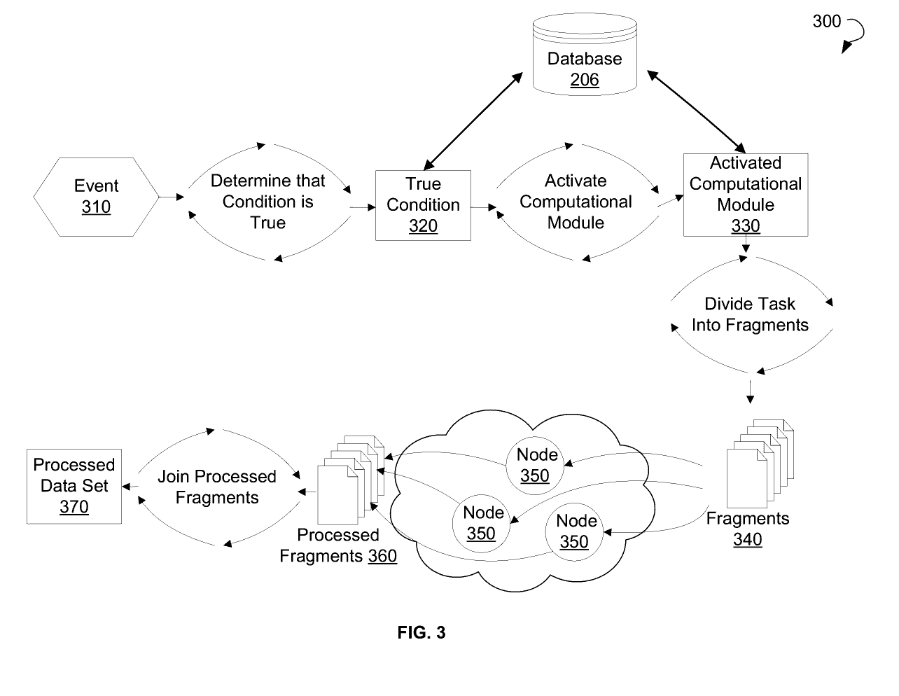

The engine 200 is further described in detail with reference to FIG. 3. FIG. 3 shows a graphical representation 300 for managing the workflow using the engine 200. Each event occurring in the workflow may be associated with one or more conditions. In other words, a condition may be satisfied when the event associated with this condition occurs. A decision node of the event-driven management engine for workflows may run a conditional loop in order to check whether the at least one condition is true. Upon occurring of an event 310, the decision node may determine that the at least one condition is true. Each true condition 320 associated with the event 310 may run a task. A task may include processing a data set, such as performing computations, sorting data, drawing diagrams, and so forth. In an example embodiment, the data set may be selected by the user (e.g., from a database). Furthermore, the data set may be obtained from testing equipment. The user may use the user interface to specify data sources from which the data set may be obtained.

After the determination that there is a true condition 320, the decision node may selectively activate at least one computational module. The computational modules and the condition associated with the computational modules may be stored in a database 206. In an example embodiment, the user may use a user interface to build or modify the computational modules, as well as specify conditions for execution of the computational modules.

Once there is at least one activated computational module 330, a fork-join queuing cluster of the event-driven management engine for workflows may allocate at least one computational module non-sequentially to participant computational nodes in a distributed cloud computing environment. The cloud computing environment may include a plurality of computational clusters to increase performance and enable parallel execution of the tasks. Furthermore, the fork join queuing cluster may process a data set according to predetermined criteria.

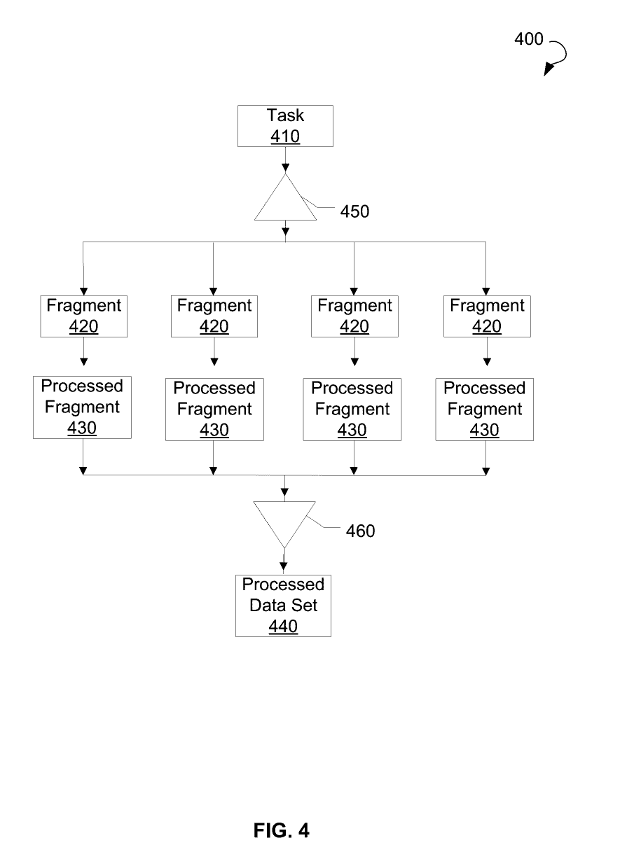

The parallel steps performed by the fork-join queuing cluster are illustrated in detail on a scheme 400 of FIG. 4. Conventional workflow execution engines support only predefined splits and cannot handle dynamic splits that depend on specific parameters. Thus the fork-join queuing cluster represents a significant enhancement over the prior art. In the disclosed technology, if a number of parallel tasks are being performed, the fork join queuing cluster can split, at a fork point 450, incoming task 410 into a number of sub-tasks represented as fragments 420. In contrast to the prior art workflow execution engines, the splits can be determined when the fork join queuing cluster starts splitting tasks. The fragments 420 can be processed by numerous computational nodes (not shown). After processing of the fragments 420, the processed fragments 430 may be joined at a join point 460 into a processed data set 440. It should be noted that splitting steps need to be finalized before the joining step.

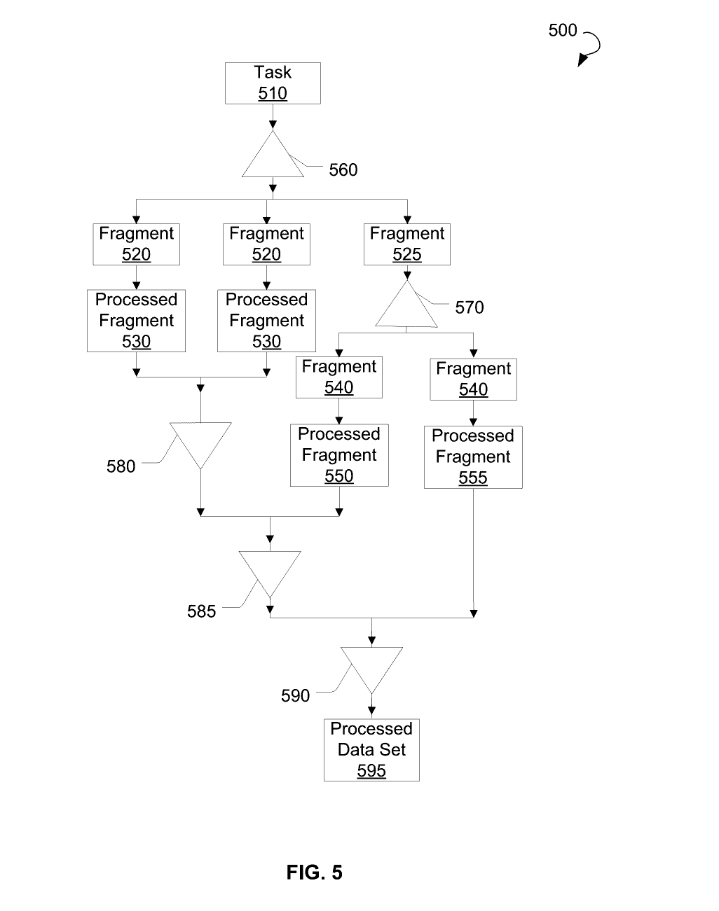

FIG. 5 shows a flow chart 500 for performing asymmetric splitting and joining by the fork join queuing cluster. Conventional workflow execution engines require pairs of fork and join points. In the disclosed technology, fork points do necessarily have corresponding join points. Thus, the fork join queuing cluster shown in FIG. 5 has two fork points and three join points. Fork points and join points may be located anywhere in the workflow. In fact, any tool that allows input from multiple sources can serve as a join point. If the join point has an input from several fork points, the join point can join the fragments when results from all fork points are available. This greatly enhances the flexibility and efficiency of the disclosed technology over the conventional workflow execution engines of the prior art.

As shown on FIG. 5, the fork-join queuing cluster may split, at a fork point 560, an incoming task 510 into a number of sub-tasks represented as fragments 520, 525. The fragments 520 can be processed by numerous computational nodes (not shown). After processing of the fragments 520, the processed fragments 530 can be joined at a join point 580.

The fragment 525 can still be too complex for processing by a single computational node. Therefore, the fragment 525 may be split, at a fork point 570, into a number of fragments 540. The fragments 540 may be processed by the computational nodes. After processing of the fragments 540, some of the processed fragments, in particular the processed fragments 550, can be joined, at a join point 585, with the processed fragments joined at the join point 580. Another portion of the processed fragments, in particular the processed fragments 555, can be joined, at a join point 590, with the processed fragments joined at the join point 585. After joining at the join point 590, a processed data set 595 can be obtained.

Referring again to FIG. 3, the fork join queuing cluster may include a master node and participant computational nodes. The master node may be configured to receive tasks associated with the computational module, divide the tasks into a plurality of fragments, and distribute fragments to participant computational nodes. The participant computational nodes may be configured to process the fragments and send processed fragments to the master node.

Specifically, allocation of the computational module to the participant computational nodes may be performed by dividing tasks associated with the computational module into a plurality of fragments 340. Each fragment 340 may be processed on a participant computational node 350. The computational module may be configured to use one or more fork join queuing clusters configured to divide the tasks for service by the participant computational nodes 350. The participant computational nodes 350 may process the fragments 340 to obtain processed fragments 360. After processing by the participant computational nodes 350, the master node may collect the processed fragments 360 from the participant computational nodes 350 and join the processed fragments 360 into a processed data set 370. The processed data set 370 may be provided to the user by a user interface.

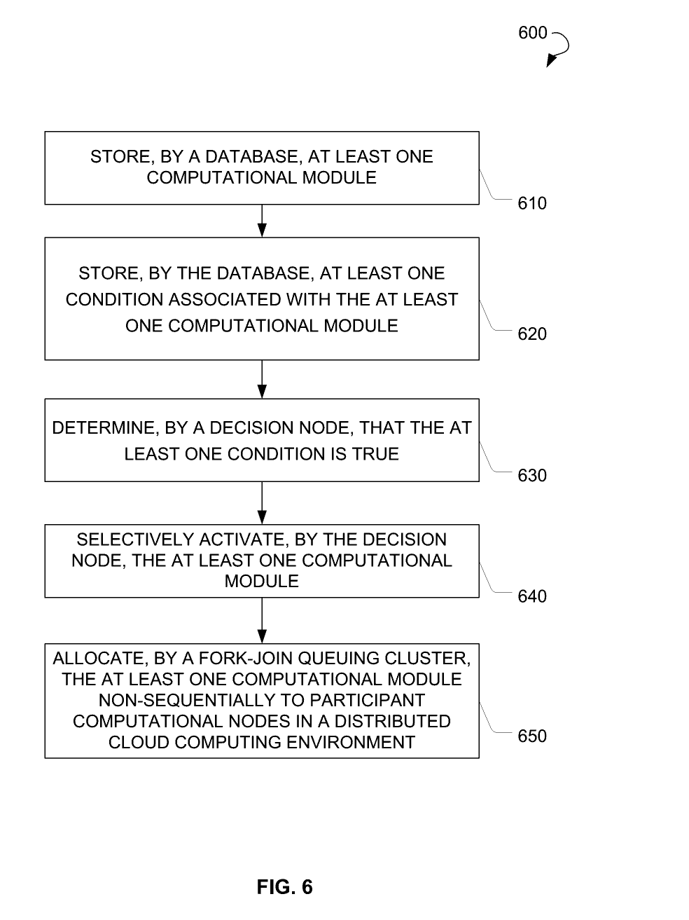

FIG. 6 is a process flow diagram showing a computer-implemented event-driven management method 600 for workflows, according to an example embodiment. The method 600 may be performed by processing logic that may comprise hardware (e.g., decision making logic, dedicated logic, programmable logic, and microcode), software (such as software running on a general-purpose computer system or a dedicated machine), or a combination of both.

The method 600 may commence with storing, by a distributed database, at least one computational module at operation 610. At operation 620, the method may comprise storing, by the distributed database, at least one condition associated with the computational module. The computation module may be not activated until the at least one condition is true.

At operation 630, a decision node may determine that the at least one condition is true by running a conditional loop configured to check whether the at least one condition is true. Based on the determination, the decision node may selectively activate the at least one computational module at operation 640.

After the computational module is activated, at operation 650, a fork join queuing cluster may allocate the computational module non-sequentially to participant computational nodes in a distributed cloud computing environment. The cloud computing environment may include a plurality of computational clusters to increase performance and enable parallel execution of the tasks. The workflow may support a plurality of biological data formats and translations between the plurality of biological data formats. In view of this, in an example embodiment, the computational module may comprise a bioinformatics tool.

The computational module may be configured to process a data set according to predetermined criteria. In an example embodiment, the computational module may be allocated to the participant computational nodes by dividing tasks associated with the computational module into a plurality of fragments. Each fragment may be processed on a participant computational node. The processed fragments may be joined into a processed data set.

Specifically, the computational module may use one or more fork-join queuing clusters configured to divide the tasks for processing by the participant computational nodes. The fork-join queuing clusters may join processed fragments after processing by the participant computational nodes. In particular, each of the fork join queuing clusters may include a master node and participant computational nodes. The master node may be configured to receive tasks associated with the computational module, divide the tasks into a plurality of fragments, and distribute fragments to participant computational nodes. The participant computational nodes may be configured to process the fragments and send processed fragments to the master node. The master node may collect the processed fragments from the participant computational nodes and join the processed fragments into a processed data set.

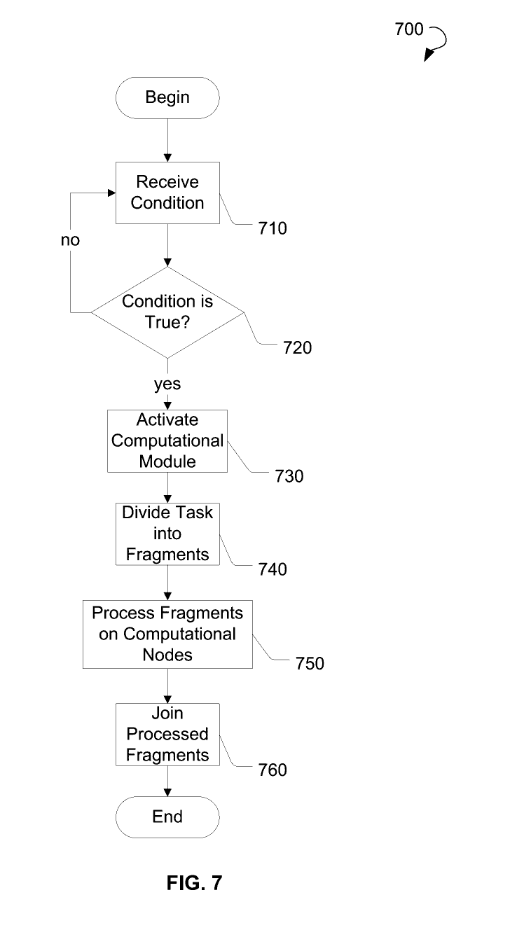

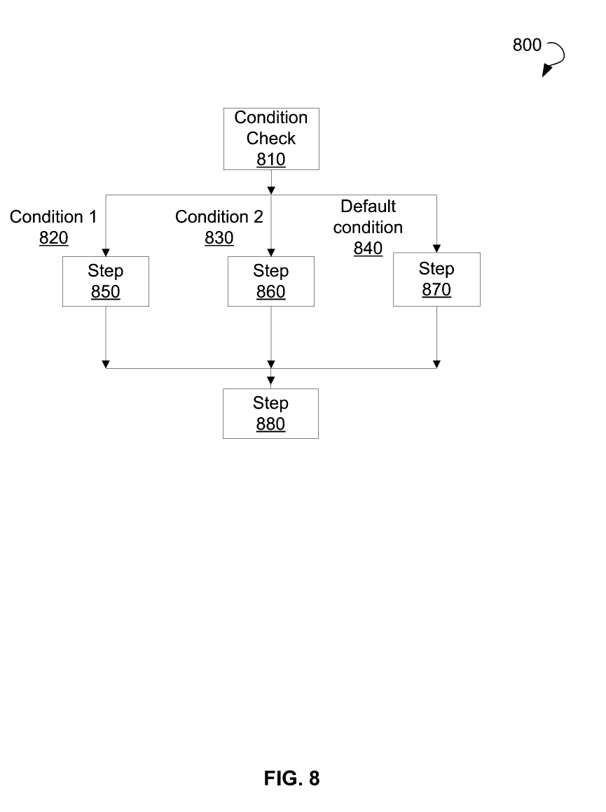

In more detail, the method 600 logics are illustrated on FIG. 7. FIG. 7 shows a flow chart illustrating a detailed computer-implemented event-driven management method 700 for workflows, in accordance with some embodiments. As shown in FIG. 7, the method 700 may commence at operation 710 with receiving, by a decision node, a condition associated with an event occurring during in the workflow.

At operation 720, the decision node may run a conditional loop to check whether the received condition is true. If the condition is not true, the decision node may run a further conditional loop at operation 710 to check further conditions. If the condition is true, the condition may process a task associated with the event. For this purpose, the decision node may activate a computational module at operation 730. The computational module may be configured to process a data set associated with the task according to predetermined criteria.

After activation of the computational module, a fork-join queuing cluster may divide the task into a number of fragments at operation 740. The computational nodes of the fork-join queuing cluster may process the fragments at operation 750. After processing, the fork-join queuing cluster may join the processed fragments into a processed data set at operation 760. Optionally, the processed data set may be represented to a user on a user interface.

FIG. 8 is a flow chart 800 illustrating method 800 for checking a condition. During a condition check 810, it is determined which of conditions 820, 830, 840 are satisfied. If conditions 820, 830 are satisfied, the decision node performs corresponding steps 850 or 860. If none of the conditions 820, 830 is satisfied, the decision node selects a default condition 840 and performs step 870. When the condition check is finalized, step 880 is executed.

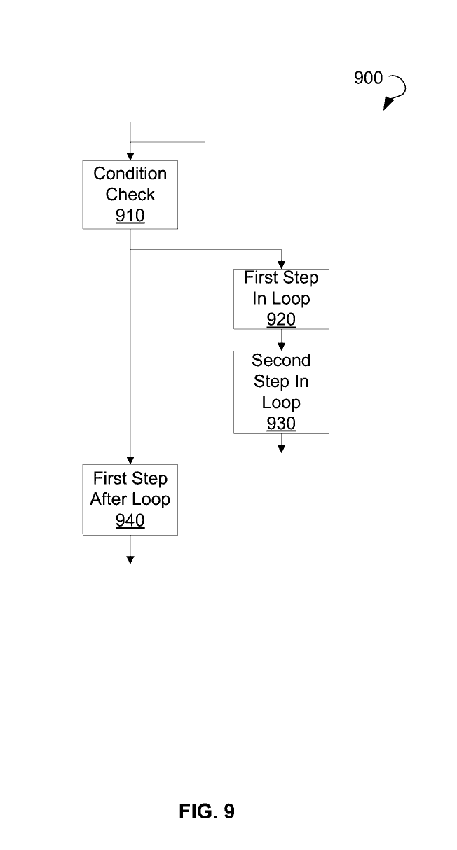

The conditional loop of step 720 in FIG. 7 is illustrated in more detail in FIG. 9 as a conditional loop 900. A condition check 910 is performed before the conditional loop 900 is executed. If, during the condition check 910, it is determined that the condition is false, all loop steps are added to the database. After adding the loop steps to the database, the loop steps shown as a first step in the loop 920 and a second step in the loop 930 are executed. If the condition is true, the conditional loop 900 terminates and all steps subsequent to the conditional loop 900 are added to the database. After the steps are added to the database, step 940 is executed. If the condition is true for the first check, none of the loop steps are executed.

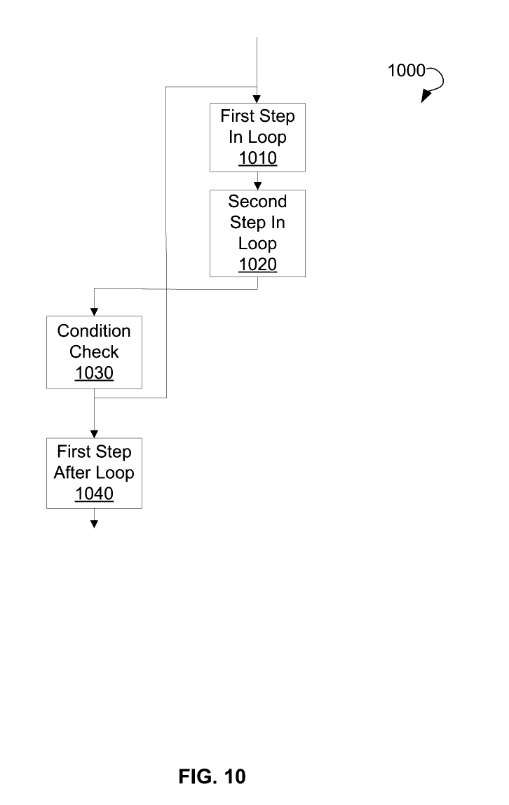

FIG. 10 illustrates another example conditional loop 1000. The loop 1000 is executed at least once before the condition check 1030. During execution of the conditional loop 1000, several steps can be performed, shown as a first step 1010 in the loop and a second step 1020 in the loop. If the condition is false, the conditional loop 1000 is executed again. The steps 1010 and 1020 of the conditional loop 1000 can be added to the database.

If the condition is true, the conditional loop 1000 terminates. All steps after the conditional loop 1000 are added to the database. After adding the steps to database, the first step 1040 is executed.

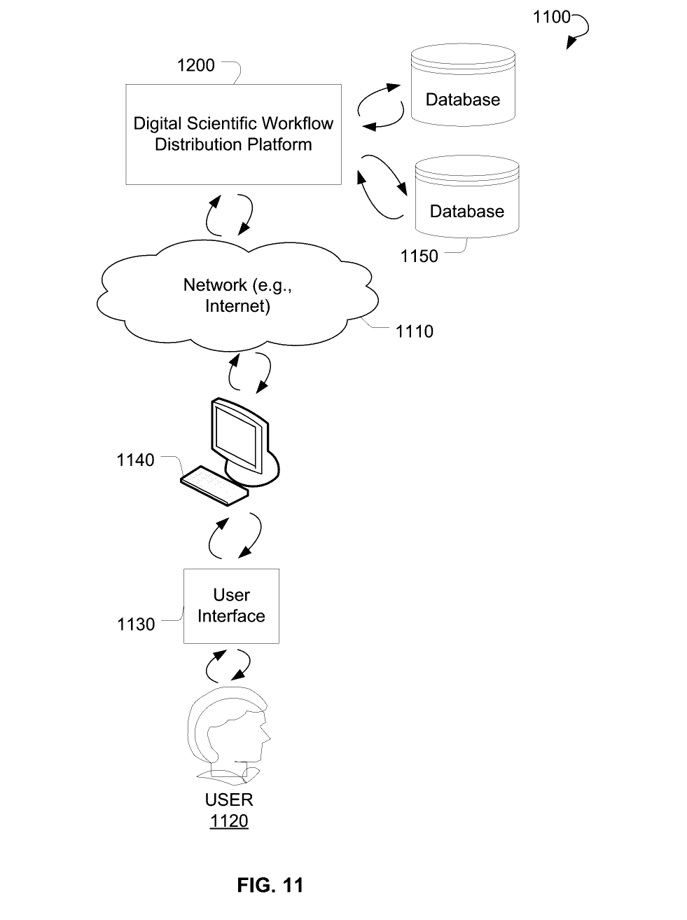

FIG. 11 illustrates an environment 1100 within which a digital workflow distribution platform and a method for workflow distribution can be implemented. The environment 1100 includes a network 1110, a user 1120, a digital workflow distribution platform 1200, a user interface 1130, one or more user devices 1140, and a database 1150.

The network 1110 includes the Internet or any other network capable of communicating data between devices. Suitable networks include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 1110 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 1110 includes a network of data processing nodes that are interconnected for the purpose of data communication. Generally, the network 1110 includes a number of similar or dissimilar devices connected together by a transport medium enabling communication between the devices by using a predefined protocol. Those skilled in the art will recognize that the present disclosure may be practiced within a variety of network configuration environments and on a variety of computing devices.

The user device 1140, in some example embodiments, includes a Graphical User Interface (GUI) for displaying the user interface 1130. In a typical GUI, instead of offering only text menus or requiring typed commands, the platform 1200 presents graphical icons, visual indicators, or special graphical elements called widgets. The user interface 1130 is utilized as a visual front-end to allow the user 1120 to build and modify complex tasks with little or no programming expertise.

The user device 1140 includes a mobile telephone, a computer, a lap top, a smart phone, a phablet, tablet PC, and so forth. In some embodiments, the user device 1140 is associated with one or more users 1120. The user device 1140 is configured to utilize icons used in conjunction with text, labels, or text navigation to fully represent the information and actions available to the user 1120. The user 1120, in some example embodiments, is a person interacting with the user interface 1130 via one of the user devices 1140. The user 1120 may include a person that uses the platform 1200 for his or her needs. For example, the user 1120 includes a scientist intending to use a workflow provided by the platform 1200 for performing a series of computational or data manipulation steps. The platform 1200 can be connected to one or more databases 1150. The databases 1150 can store data associated with the workflows, the user 1120, and other data needed for development of the workflow.

As shown on FIG. 11, the user 1120 can access the platform 1200 via the user interface 1130 presented on the user device 1140. The user 1120 can send a request to the platform 1200 via the user interface 1130. In an example embodiment, the request can be provided by selection of the workflow to be acquired. In response to the request of the user 1120, the platform 1200 imports the selected workflow into a user environment.

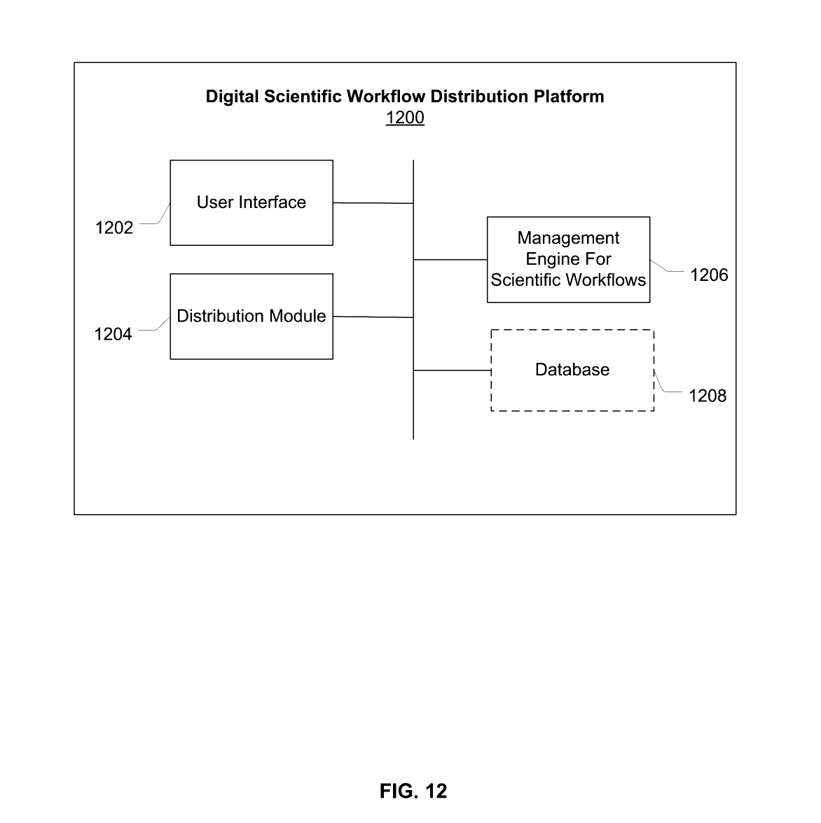

FIG. 12 shows a detailed block diagram of the digital workflow distribution platform 1200, in accordance with an example embodiment. The platform 1200 can include a user interface 1202, a distribution module 1204, a management engine 1206 for workflows, and, optionally, a database 1208.

The user can utilize the user interface 1202 to access the platform 1200. The user interface 1202 can allow the user to select one of the workflows from the workflows available on the platform 1200. The user can make the selection based on one or more parameters associated with the workflow. Specifically, after accessing the platform 1200, the user can view one or more of the following parameters: a list of available workflows, specific information associated with each of the workflows, tools available for each of the workflows, price of the workflows, and so forth. In an example embodiment, the user can select the workflow of interest by clicking on the workflow pictogram.

In an example embodiment, the user interface 1202 can be configured to provide one or more of the following functionalities: searching for the workflow, viewing information associated with the workflow, purchasing the workflow, importing the workflow into a user environment, enabling a developer to develop a tool and upload the tool to the management engine for workflows, and so forth.

The user interface 1202 can be regulated by a platform operator. In an example embodiment, each workflow requires an approval process and compliance with predetermined guidelines. The approval process and checking compliance of the workflow with predetermined guidelines can be performed by the platform operator.

The distribution module 1204 of the platform 1200 can be configured to enable the user to acquire the workflow. Furthermore, the distribution module 1204 can be operable to enable importing the workflow into a user environment. For example, the workflow can be implemented as application installed on a user device or as a web-based application.

In an example embodiment, the distribution module 1204 can allow assessing fees from a workflow user. For example, a user account associated with the platform 1200 can be charged for the workflow to be imported into the user environment. Thus, for example, before the workflow is imported into the user environment, an amount corresponding to the price of the workflow can be subtracted from the user account and transferred to an account associated with the workflow owner. Moreover, a percentage of the fees or a flat amount can be paid to the platform operator. The workflow can be sold on a subscription basis, for example by paying a monthly fee or an annual fee. In another example embodiment, the workflow can be sold on a per use basis, for a one-time lump sum, and so forth.

The workflow is available as SaaS so that the workflow and associated data are centrally hosted in a cloud environment. In such environment, a user can access the workflow via a web browser using a thin client. When the workflow is provided as a SaaS, its use can be easily tracked and the user charged per use.

In a multi-tenant SaaS environment, the cost of user provisioning (i.e., creation, maintenance and deactivation of user attributes) is relatively low. Thus, the workflow provider may even offer the user a free workflow service with limited functionality or scope. In this case, the fees can be charged only for enhanced functionality in addition to the basic free workflow service.

The management engine 1206 for workflows of the platform 1200 can be configured to support development of the workflow imported into the user environment. The management engine 1206 for workflows can comprise a decision node, a fork join queuing cluster, and a distributed database. The management engine 1206 for workflows can be communicatively coupled to an application running in the user environment and enable the user to manage and define a series of tasks within the application. Various events can occur as the applications runs. These events can include user actions, sensor outputs, notification from other programs, and so forth. Each event can be associated with one or more conditions that are stored in the management engine 1206 for workflows.

In an example embodiment, the decision node is configured to determine that at least one condition is true. The determination that the at least one condition is true can be performed by running a conditional loop. The conditional loop can be configured to check whether the at least one condition is true. The decision node can be further configured to selectively activate, based on the determination, the at least one computational module. The computational module can include a computational tool. The workflow can support a plurality of biological data formats as well as translations between the plurality of biological data formats. A computational tool can pertain to a specific field of science (for example, bioinformatics). In one embodiment, the computational tool is a bioinformatics tool enabling the user to process specific bioinformatics tasks.

After activation of the computational module, the fork join queuing cluster can allocate at least one computational module non-sequentially to participant computational nodes. The participant computational nodes can be located in a distributed cloud computing environment. Using the participant computational nodes, the fork join queuing cluster can process a data set according to predetermined criteria. In a further example embodiment, the management engine 1206 for workflows of the platform 1200 is the event-driven management engine for workflows 200 in FIG. 2.

The distributed database 1208 can be configured to store at least one computational module and at least one condition associated with the at least one computational module. Furthermore, the distributed database 1208 can be configured to store data associated with the workflows, the user, and other data needed for development of the workflow by the user. Once the workflow is imported into the user environment, the user can be able to edit the workflow. Furthermore, the user can edit parameters and tools associated with the workflow.

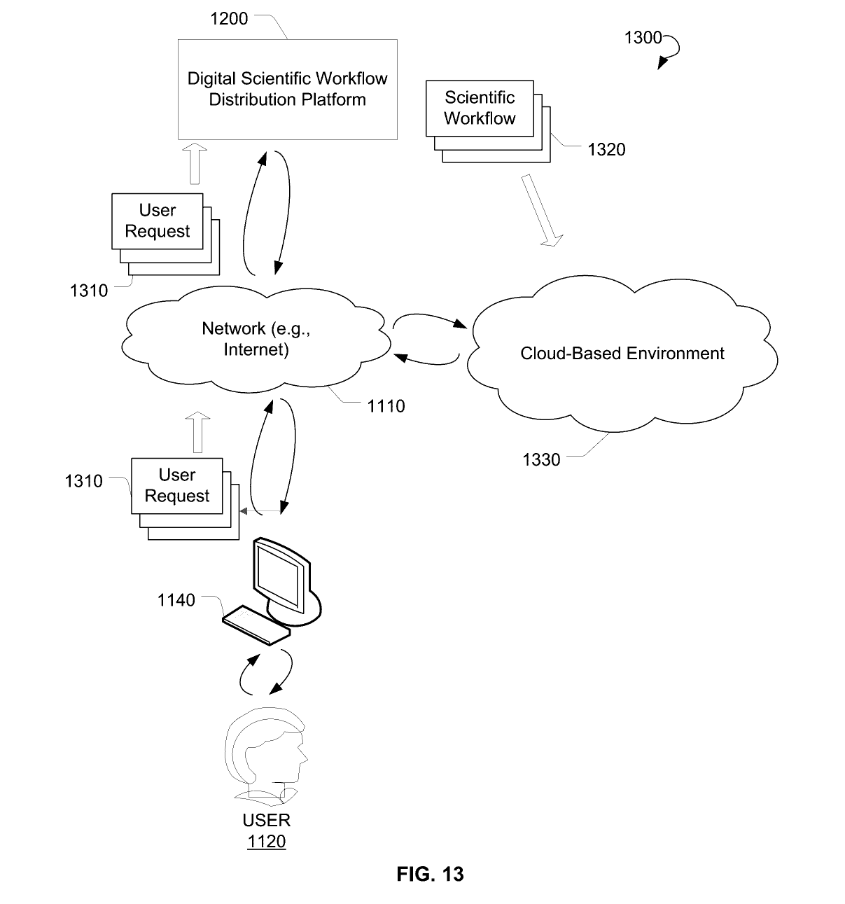

FIG. 13 illustrates a method for workflow distribution 1300, according to another example embodiment. The user 1120 can use a user device 1140 having a user interface to connect to the digital workflow distribution platform 1200. The user device 1140 can be connected with the digital workflow distribution platform 1200 via the network 1110. Upon connecting to the digital workflow distribution platform 1200, the user 1120 can search for workflows that can be acquired from the digital workflow distribution platform 1200. The user 1120 can view information associated with the available workflows. The user 1120 can select a workflow and send a user request 1310 to the digital workflow distribution platform 1200.

In an example embodiment, the user request 1310 can be related to acquiring the workflow and importing the workflow into the user environment. Upon receiving the user request 1310, the digital workflow distribution platform 1200 processes the user request 1310. After processing the user request 1310, the digital workflow distribution platform 1200 can provide the workflow 1320 to the cloud-based environment 1330 of the user 1120. In the embodiment shown on FIG. 13, the workflow 1320 is a web-based workflow and is configured to be imported into the cloud-based environment 1330. The user 1120 can access the cloud-based environment 1330 via the user interface on the user device 1140. Providing the workflow 1320 to the user 1120 can include importing workflow 1320 into the cloud-based environment 1330. After import of the workflow 1320, the user 1120 may edit the workflow 1320 according to his or her needs.

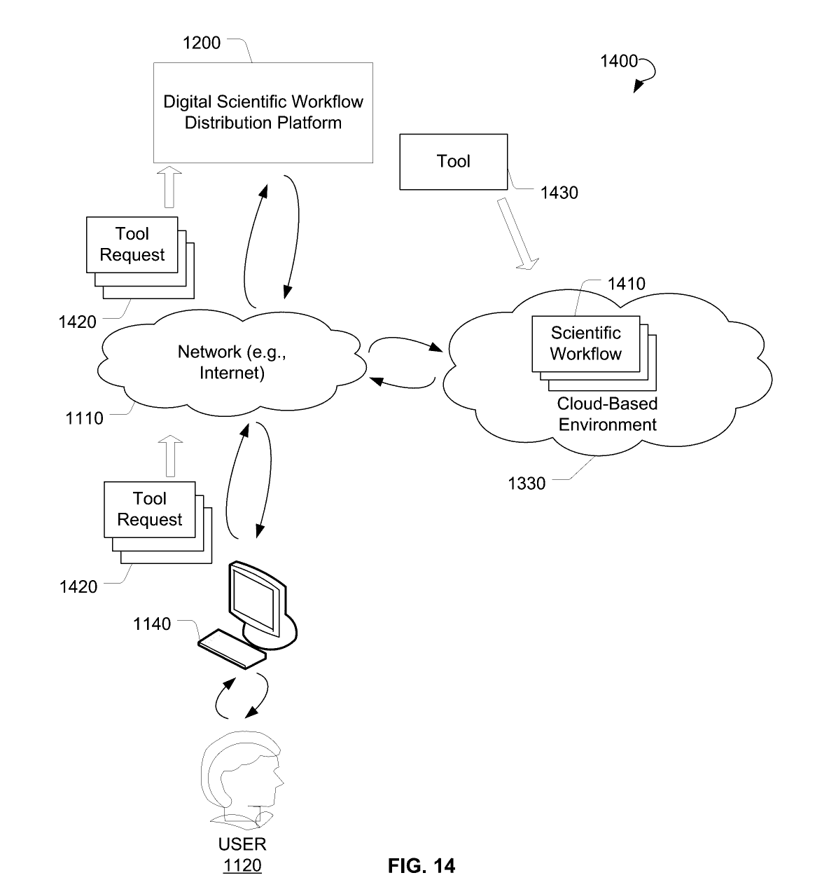

FIG. 14 illustrates a method for workflow tool distribution 1400, according to an example embodiment. After import of the workflow into the cloud-based environment shown on FIG. 13, the user 1120 can develop the workflow 1410 by acquiring tools associated with the workflow 1410. The user 1120 can utilize a user device 1140 having a user interface 1130 to connect to the digital workflow distribution platform 1200 via the network 1110. Upon connecting to the digital workflow distribution platform 1200, the user 1120 can search for tools available for acquisition in the digital workflow distribution platform 1200. The tools are then associated with the workflow 1410 installed in the cloud-based environment 1330 (i.e., the tools can be added into the workflow 1410). The user 1120 views information associated with the available tools and selects the tools of interest. The user 1120 can send a tool request 1420 to the digital workflow distribution platform 1200. In an example embodiment, the tool request 1410 includes acquiring the tool to be added into the user environment 1330. Upon receiving the tool request 1420, the digital workflow distribution platform 1200 can process the tool request 1420. After processing the tool request 1420, the digital workflow distribution platform 1200 can add the tool 1430 to the workflow 1410 in the cloud-based environment 1330. After adding the tool 1430, the user 1120 is able to edit the tool 1430 associated with the workflow 1410.

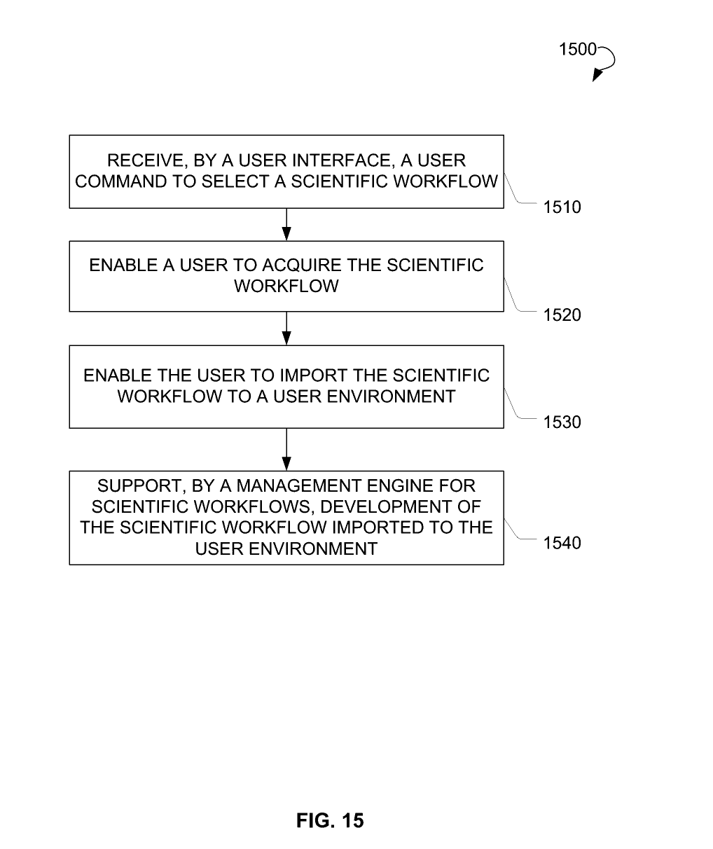

FIG. 15 is a process flow diagram showing a computer-implemented method 1500 for workflow distribution, according to an example embodiment. The method 1500 can be performed by processing logic that comprises hardware (e.g., decision making logic, dedicated logic, programmable logic, and microcode), software (such as software running on a general-purpose computer system or a dedicated machine), or a combination of both.

The method 1500 can commence with receiving, by a user interface, a user command to select a workflow at operation 1510. The user can make a selection based on one or more parameters associated with the workflow. At operation 1520, the user is able to acquire the workflow. At operation 1530, the user is able to import the workflow into a user environment. In an example embodiment, the workflow can include an application installed on a user device, such as client software accessing the platform or a web-based workflow. The workflow can be sold on a subscription basis, a per use basis, a one-time lump sum basis, a peer-to-peer basis, or the like. In an example embodiment, the workflow is distributed as SaaS.

After import of the workflow, a management engine 1206 for workflows supports development of the workflow imported into the user environment at operation 1540. In order to support the development of the workflow, the management engine for workflows can include a decision node, a fork-join queuing cluster, and a distributed database. The decision node is configured to determine that at least one condition associated with an event occurring in the workflow is true. The determination that the at least one condition is true is performed by running a conditional loop configured to check whether the at least one condition is true. Furthermore, based on the determination, the decision node can selectively activate at least one computational module. The computational module can processes a task associated with the true condition. The fork join queuing cluster can be configured to allocate the at least one computational module non-sequentially to participant computational nodes in a distributed cloud computing environment. The fork join queuing cluster can process a data set according to predetermined criteria. The distributed database can be configured to store the computational module and the condition associated with the computational module. The computation module is not activated until the at least one condition is true. Development of the workflow includes modifying the workflow and modifying parameters and tools associated with the workflow after the workflow is imported into the user environment.

In an example embodiment, the user interface is configured to provide one or more of the following functionalities: searching for the workflow, viewing information associated with the workflow, purchasing the workflow, importing the workflow into a user environment, enabling a developer to develop a tool and upload the tool to the management engine for workflows, and so forth. The user interface can be regulated by a platform operator. Each workflow may require an approval process and compliance with predetermined guidelines. The platform operator can perform the approval process and control compliance of the workflow with the predetermined guidelines.

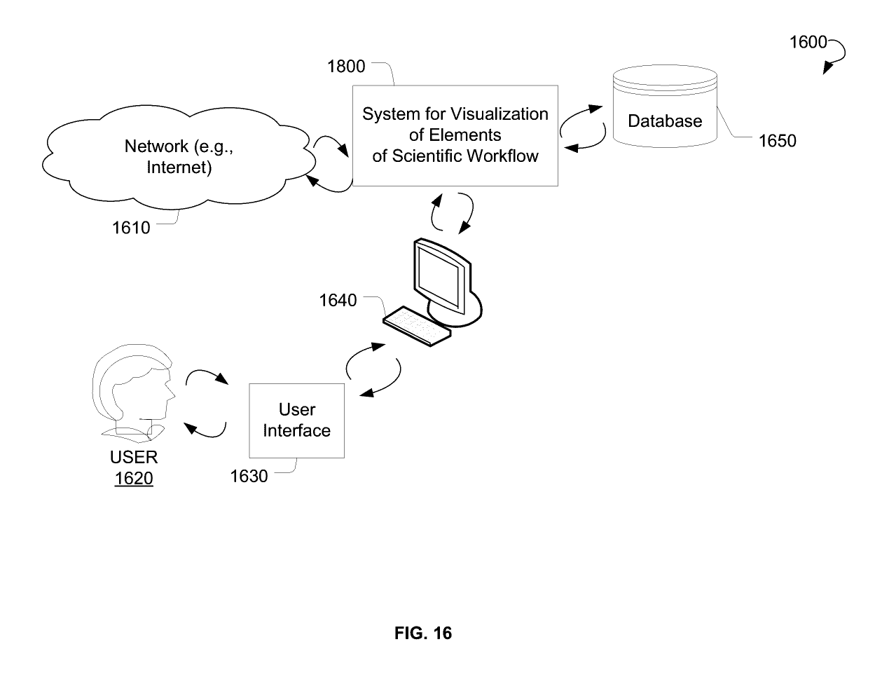

FIG. 16 illustrates an environment 1600 within which a method for visualization of elements of a workflow and a system can be implemented. The environment 1600 may include a network 1610, a user 1620, a system 1800 for visualization of elements of a workflow, a user interface 1630, one or more client devices 1640, and a database 1650.

The network 1610 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 1610 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 1610 may include a network of data processing nodes that are interconnected for the purpose of data communication. The network 1610 may include a Software-defined Networking (SDN). The SDN may include one or more of the above network types. Generally the network 1610 may include a number of similar or dissimilar devices connected together by a transport medium enabling communication between the devices by using a predefined protocol. Those skilled in the art will recognize that the present disclosure may be practiced within a variety of network configuration environments and on a variety of computing devices.

The client device 1640, in some example embodiments, may include a Graphical User Interface (GUI) for displaying the user interface 1630. In a typical GUI, instead of offering only text menus or requiring typed commands, the user interface 1630 may present graphical icons, visual indicators, or special graphical elements called widgets. The user interface 1630 may be utilized as a visual front-end to allow the user 1620 to build and modify workflows with little or no programming expertise.

The client device 1640 may include a mobile telephone, a computer, a lap top, a smart phone, a tablet personal computer (PC), and so forth. In some embodiments, the client device 1640 may be associated with one or more users 1620. The client device 1640 may be configured to utilize icons used in conjunction with text, labels, or text navigation to fully represent the information and actions available to the user 1620. The user 1620, in some example embodiments, may be a person interacting with the user interface 1630 via one of the client devices 1640. The user 1620 may represent a person that uses the system 1800 for visualization of elements of a workflow for his or her needs. For example, the user 1620 may include a scientist using the system 1800 for visualization of the elements of the workflow for performing a series of computational or data manipulation steps. As shown on FIG. 16, the user 1620 may input data to an application running on the client device 1640. The application may utilize the system 1800 for visualization of the elements of the workflow. Based on the input of the user 1620, the system 1800 for visualization of the elements of the workflow may visualize the workflow of the application running on the client device 1640. The system 1800 for visualization of the elements of the workflow may be connected to one or more databases 1650. The databases 1650 may store data associated with tasks that need to be executed in the course of the workflow, rules associated with positioning workflow elements on a layout of the workflow, and so forth.

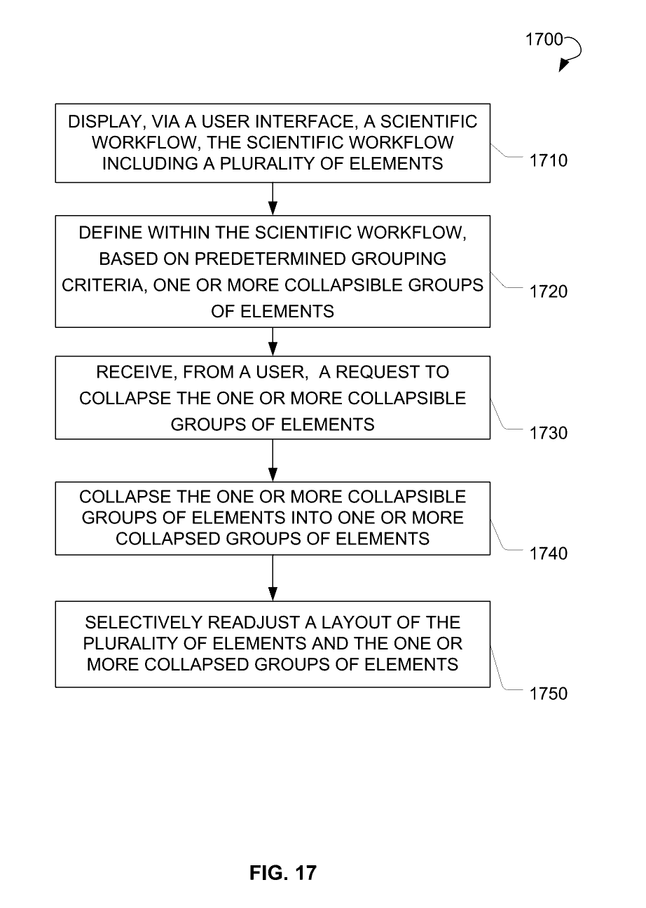

FIG. 17 is a process flow diagram showing a computer-implemented method 1700 for visualization of elements of a workflow, according to an example embodiment. The method 1700 may be performed by processing logic that may comprise hardware (e.g., decision making logic, dedicated logic, programmable logic, and microcode), software (such as software running on a general-purpose computer system or a dedicated machine), or a combination of both.

The method 1700 commences with displaying, via a user interface, the workflow at operation 1710. The workflow includes a plurality of elements, such as a word, an idea, a task, and so forth. The elements may be shown on the user interface in a form of blocks. Connections between elements may be shown as connections between the blocks. At operation 1720, the method comprises defining one or more collapsible groups of elements within the workflow. The defining is made based on predetermined grouping criteria. The one or more collapsible groups of elements include one or more of a loop, a conditional statement, a computational tool, a marker, an algorithm, a nested workflow, and so forth.

At operation 1730, a request to collapse the one or more collapsible groups of elements is received from a user. After receiving the request, the one or more collapsible groups of elements is collapsed into one or more collapsed groups of elements at operation 1740.

After collapsing of the one or more collapsible groups of elements, at operation 1750, a layout of the plurality of elements and the one or more collapsed groups of elements is selectively readjusted. A block depicting the collapsed group of elements on the layout may be of a greater size than the blocks of the collapsible group of elements.

In an example embodiment, the method 1700 further comprises receiving, from the user, a request to expand the one or more collapsed groups of elements formed at operation 1740. In response to the request, the collapsed group of elements is expanded into the one or more groups of elements. After expanding the groups of elements, the layout of the workflow is selectively readjusted.

In an example embodiment, the method 1700 optionally comprises receiving a request from the user to add a further element to the workflow. In response to the request, the further element is added to the workflow and the layout of the workflow is selectively readjusted.

In an example embodiment, the method 1700 optionally comprises receiving a request from the user to remove a further element from the workflow. In response to the request, the further element is removed from the workflow and the layout of the workflow is selectively readjusted.

In a further example embodiment, the method 1700 optionally comprises receiving a request from the user to modify a further element of the workflow. In response to the request, the further element of the workflow is modified and the layout of the workflow is selectively readjusted.

In some example embodiments, the method 1700 comprises adding a space saving element to the layout of the workflow. The space saving element is configured to reorder the arrangement of the elements of the workflow to optimize the arrangement of the elements on the layout. In some embodiments, the reordering takes place automatically. That is, each element of the workflow is self-positioned in response to receiving user requests to collapse the collapsible groups of elements, to expand the collapsed groups of elements, to add further elements to the workflow, and the like.

In an example embodiment, the method 1700 comprises receiving a request to create a visualization of an element or a group of elements of the workflow. The visualization allows the user to edit the element or the group of elements while working on the workflow. In response to the request, the visualization of the element or the group of elements of the workflow is created.

In an example embodiment, the visualization comprises an inline editor. The inline editor allows users to dynamically edit elements shown via the user interface. The inline editor enables the user to create markers of the elements of the workflow and depict the markers as an expandable block. The marker may include a description of the element included in the expandable block. After creation of the markers, the markers are depicted on the layout.

When the user needs to execute the elements of the block marked by the marker, the user gives a request to expand the expandable block marked by the marker. In response to the request, the expandable block expands and the user selects the needed element of the workflow. The user may select several markers, the elements of which are to be executed in the workflow. In such a case, the elements of the unselected markers are not executed during the workflow.

Furthermore, in an example embodiment, the user creates an algorithm for a selected group of elements of the workflow and marks the selected group of elements with a marker describing the algorithm. All elements of the selected group of elements are executed using the algorithm created by the user.

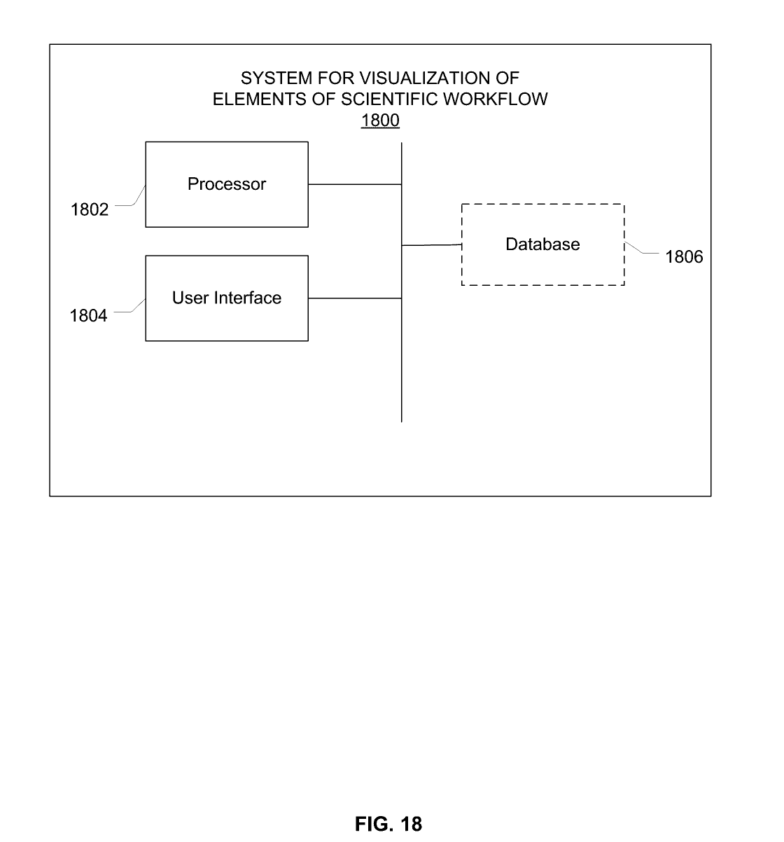

FIG. 18 shows a detailed block diagram of a system 1800 for visualization of elements of a workflow, in accordance with an example embodiment. The system 1800 may include a processor 1802, a user interface 1804, and, optionally, a database 1806.

In an example embodiment, the processor 1802 is configured to define, based on predetermined grouping criteria, one or more collapsible groups of elements within the workflow. Furthermore, the processor 1802 is configured to receive, from a user, a request to collapse the one or more collapsible groups of elements. In response to the request, the processor 1802 is configured to collapse the one or more collapsible groups of elements into one or more collapsed groups of elements. The one or more collapsible groups of elements include a loop, a conditional statement, a computational tool, a marker, an algorithm, a nested workflow, and so forth. After collapsing the one or more collapsible groups of elements, the processor selectively readjusts a layout of the plurality of elements and the one or more collapsed groups of elements.

In an example embodiment, the processor 1802 is further configured to receive a request to add a further element to the workflow. In response to the request, the processor 1802 adds the further element to the workflow and selectively readjusts the layout of the workflow. In a further example embodiment, the processor 1802 is further configured to receive a request to remove a further element from the workflow. In response to the request, the processor 1802 removes the further element from the workflow and selectively readjusts the layout of the workflow. In an example embodiment, the processor 1802 is further configured to receive a request to modify a further element of the workflow. In response to the request, the processor 1802 modifies the further element to the workflow and selectively readjusts the layout of the workflow.

In a further example embodiment, the processor 1802 is configured to add a space saving element to the layout of the workflow. The space saving element is configured to reorder the arrangement of the elements of the workflow to optimize the arrangement of the elements on the layout.

In a further example embodiment, the processor 1802 is configured to receive a request to create a visualization of an element or a group of elements of the workflow. The visualization allows the user to edit the element or the group of elements while working on the workflow. In response to the request, the processor 1802 creates the visualization of the element or the group of elements of the workflow. In an example embodiment, the visualization comprises an inline editor. In a further example embodiment, the processor 1802 is the digital workflow distribution platform 1200 in FIG. 12.

The user interface 1804 of the system 1800 is configured to display the workflow. The workflow includes a plurality of elements. The plurality of elements includes a word, an idea, a task, and the like. In an example embodiment, the user interface 1804 depicts the elements of the workflow as blocks. Connections between the elements of the workflow are depicted as connections between the blocks.

The databases 1806 stores data associated with the workflow, such as tasks that need to be executed in the course of the workflow, rules associated with positioning workflow elements on a layout of the workflow, and so forth.

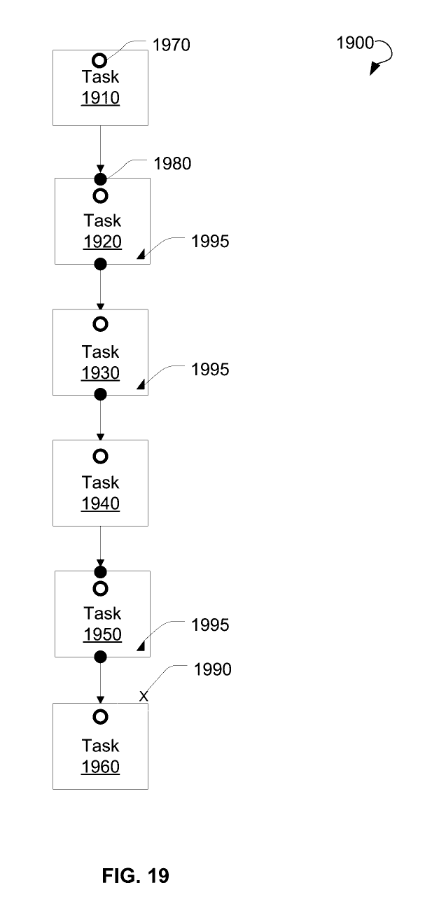

FIG. 19 shows a scheme 1900 for a workflow in a collapsed form. The workflow comprises tasks 1910-1960. Each task is shown in a separate block. The blocks of the tasks 1910-1960 comprise markers 1970, 1980, 1990, 1995. The markers 1970, 1980, 1990, 1995 show actions available to be done on the tasks 1910-1960. For example, the task 1960 may be removed or hidden from the layout of the workflow by using the marker 1990. The tasks 1920, 1930, 1950 may be expanded by using the markers 1995. The markers 1970, 1980 may represent any information relevant to the tasks 1910-1960, such as ability of the task to be expanded, obligatory task of the workflow, optional task of the workflow, and the like.

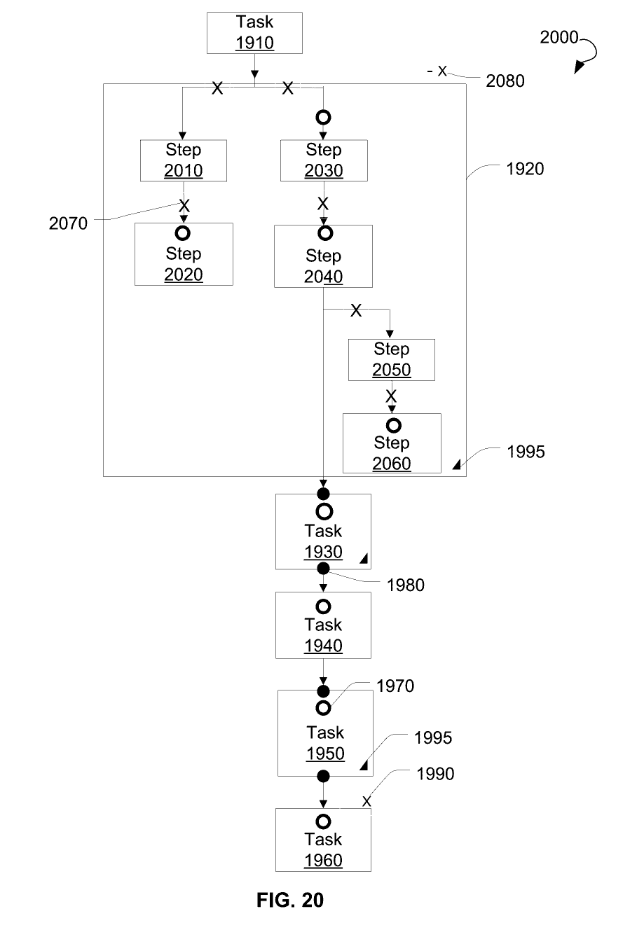

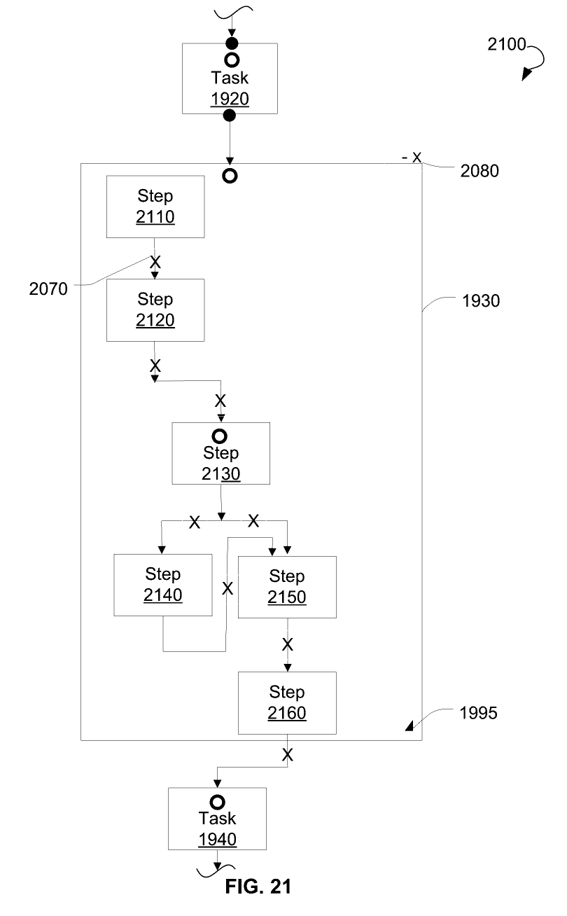

FIG. 20 shows a scheme 2000 for the collapsed workflow of FIG. 19, in which the task 1920 is expanded. The task 1920 comprises several steps shown as steps 2010-2060. The expanded task 1920 may be collapsed to the initial form using the marker 1995. The markers 2070 are used to remove the steps 2010-2060 from the task 1920. The marker 2080 is used to close the task 1920.

FIG. 21 shows a scheme 2100 for the collapsed workflow of FIG. 19, in which the task 1930 is expanded. For clear illustration, tasks 1910, 1950, 1960 are not shown on FIG. 21. The task 1930 comprises several steps shows as steps 2110-2160. The expanded task 1930 may be collapsed to the initial form using the marker 1995. The marker 2080 is used to close the task 1930. The markers 2070 are used to remove the steps 2110-2160 from the task 1930 or to remove the task 1940 from the workflow.

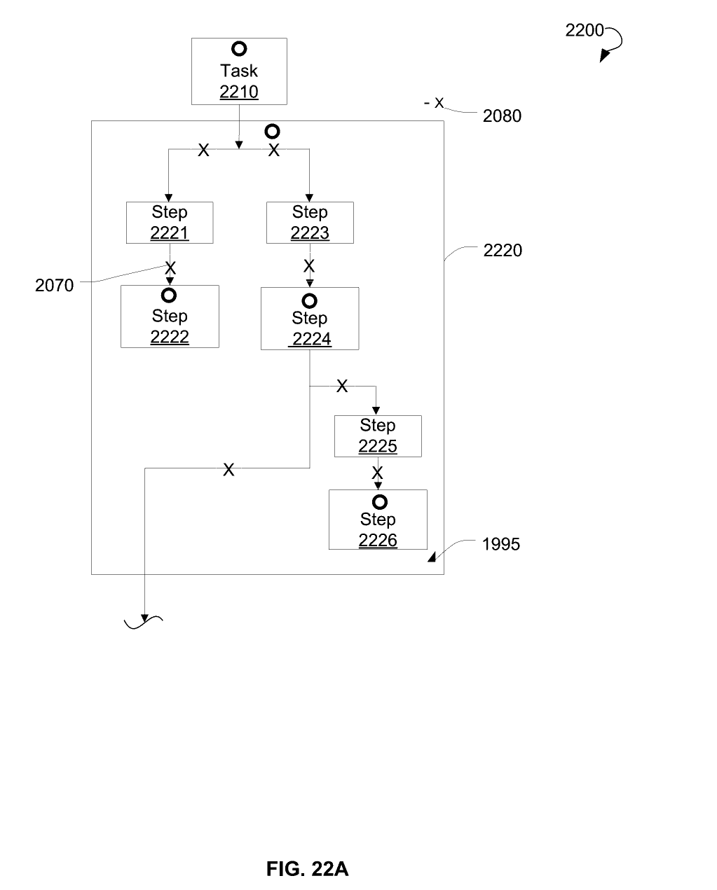

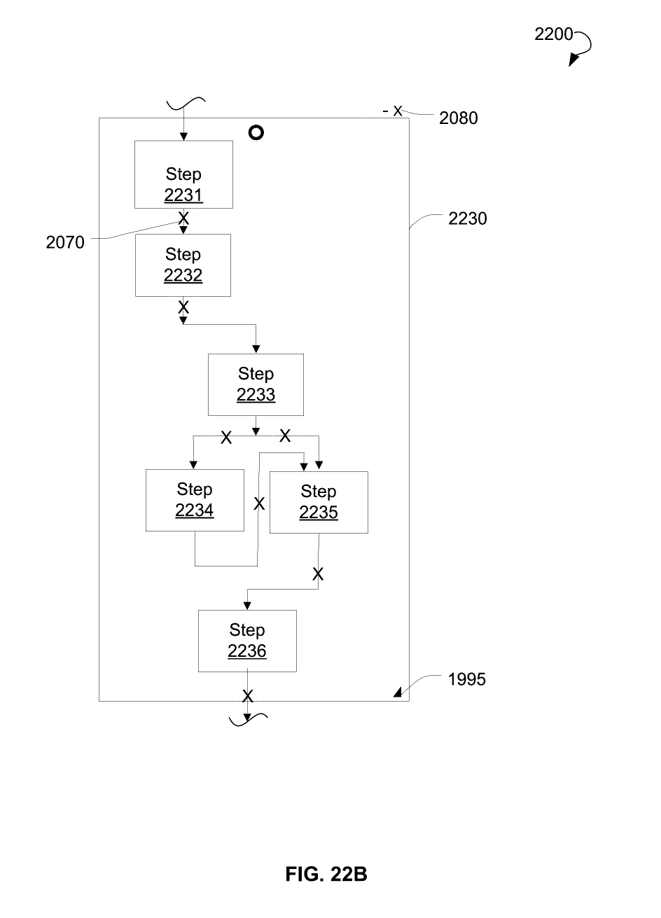

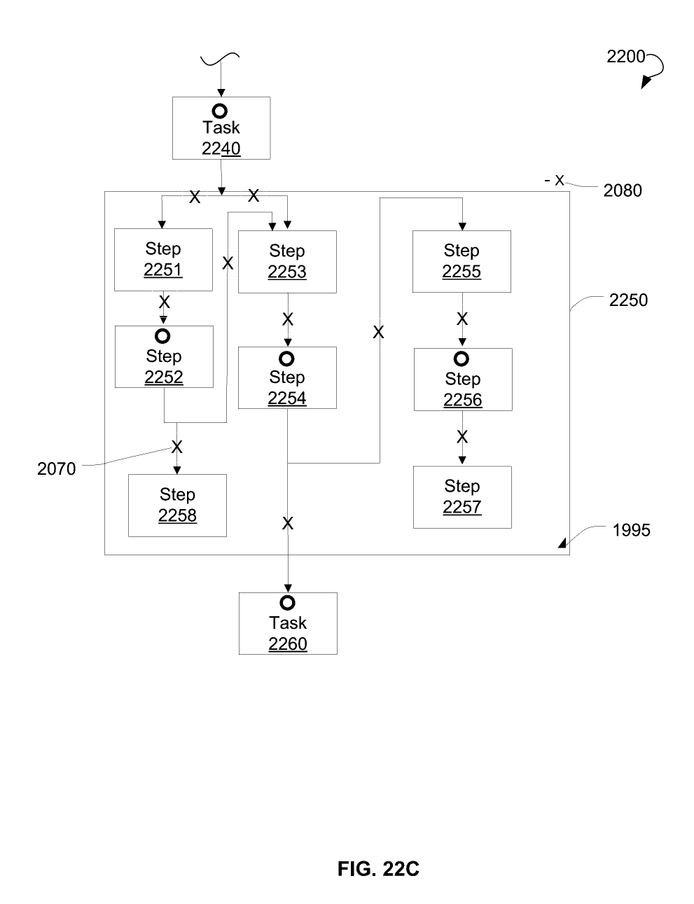

FIGS. 22A-22C show a scheme 2200 for a workflow of FIG. 19 in an expanded form. In particular, as shown on FIG. 22A, the task 2210 is non-expandable. Task 2220 is expanded and comprises steps 2221-2226. The markers 2070 are used to remove any of steps 2221-2226 from the task 2220. The expanded task 2220 may be collapsed to the initial form using the marker 1995. The marker 2080 is used to close the task 2220.

FIG. 22B shows the task 2230 in an expanded form. Task 2230 is expanded and comprises steps 2231-2236. The marker 1995 may be used to collapse the task 2230. The markers 2070 are used to remove any of steps 2231-2236 from the task 2230. The marker 2080 is used to close the task 2230.

As shown on FIG. 22C, the tasks 2240 and 2260 are non-expandable. The task 2250 is expanded and comprises steps 2251-2257. The marker 1995 is used to collapse the task 2250. The markers 2070 are used to remove any of steps 2251-2257 from the task 2250. The marker 2080 is used to close the task 2250.

The tasks 2220, 2230, 2250 represent nested workflows comprised in the workflow shown on FIGS. 22A-22C. Specifically, the tasks 2220, 2230, 2250 are workflows that are executed during running of the workflow shown on FIGS. 22A-22C.

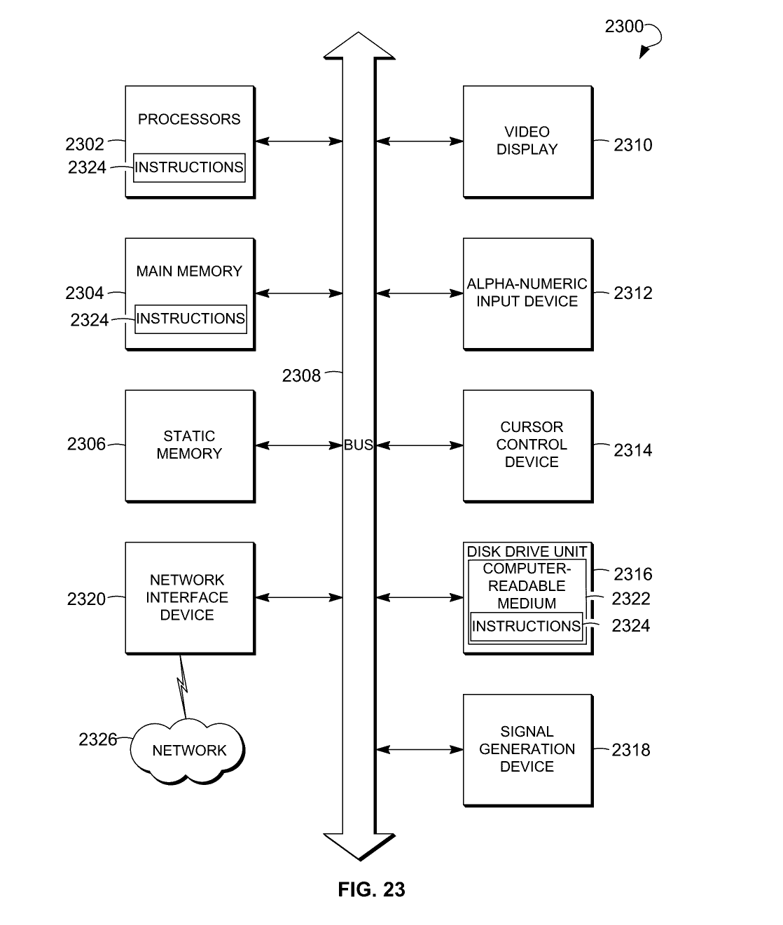

FIG. 23 shows a diagrammatic representation of a machine in the example electronic form of a computer system 2300, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a PC, a tablet PC, a set-top box (STB), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2300 includes a processor or multiple processors 2302 (e.g., a central processing unit (CPU), a graphics processing unit (GPU), or both), a main memory 2304, and a static memory 2306, which communicate with each other via a bus 2308. The computer system 2300 may further include a video display unit 2310 (e.g., a liquid crystal display (LCD) or a cathode ray tube (CRT)). The computer system 2300 may also include an alphanumeric input device 2312 (e.g., a keyboard), a cursor control device 2314 (e.g., a mouse), a disk drive unit 2316, a signal generation device 2318 (e.g., a speaker), and a network interface device 2320.

The disk drive unit 2316 includes a non-transitory computer-readable medium 2322, on which is stored one or more sets of instructions and data structures (e.g., instructions 2324) embodying or utilized by any one or more of the methodologies or functions described herein. The instructions 2324 may also reside, completely or at least partially, within the main memory 2304 and/or within the processors 2302 during execution thereof by the computer system 2300. The main memory 2304 and the processors 2302 may also constitute machine-readable media.

The instructions 2324 may further be transmitted or received over a network 2326 via the network interface device 2320 utilizing any one of a number of well-known transfer protocols (e.g., Hyper Text Transfer Protocol (HTTP)).

While the computer-readable medium 2322 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

Thus, methods and systems for visualization of elements of a workflow, for workflow distribution, and for event-driven management for workflows are disclosed. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A method for visualization of elements of a workflow that defines an analysis of very large data sets using multi-node compute clusters, the method comprising:
displaying, via a graphical user interface (GUI), the workflow, the workflow including a plurality of elements;
defining within the workflow, based on predetermined grouping criteria, one or more collapsible groups of elements;
receiving, from a user, a request to collapse the one or more collapsible groups of elements;
collapsing the one or more collapsible groups of elements into one or more collapsed groups of elements; and
selectively readjusting a layout of the plurality of elements and the one or more collapsed groups of elements.

2. The method of claim 1, further comprising:
receiving a request to add a further element to the workflow;
adding the further element to the workflow; and
selectively readjusting the layout of the workflow.

3. The method of claim 1, further comprising:
receiving a request to remove a further element from the workflow;
removing the further element from the workflow; and
selectively readjusting the layout of the workflow.

4. The method of claim 1, further comprising:
receiving a request to modify a further element of the workflow;
modifying the further element of the workflow; and
selectively readjusting the layout of the workflow.

5. The method of claim 1, wherein the one or more collapsible groups of elements include one or more of a loop, a conditional statement, a computational tool, a marker, an algorithm, and a nested workflow.

6. The method of claim 1, wherein the plurality of elements comprises one or more of a word, an idea, and a task.

7. The method of claim 1, further comprising adding a space saving element to the layout of the workflow.

8. The method of claim 1, further comprising:
receiving a request to create a visualization of an element or a group of elements of the workflow, the visualization allowing the user to edit the element or the group of elements while working on the workflow; and
creating the visualization of the element or the group of elements of the workflow.

9. The method of claim 8, wherein the visualization comprises an inline editor.

10. The method of any one of claims 1 through 9, wherein the multimode compute cluster is Hadoop-based.

11. The method of any one of claims 1 through 10, wherein the workflow is a scientific workflow.

12. The method of claim 11, wherein the scientific workflow is a bioinformatics workflow analyzing very large genomic data sets.

13. A system for visualization of elements of a workflow that defines an analysis of very large data sets using multi-node compute clusters, the system comprising:
a processor configured to:
define within the workflow, based on predetermined grouping criteria, one or more collapsible groups of elements;
receive, from a user, a request to collapse the one or more collapsible groups of elements;
collapse the one or more collapsible groups of elements into one or more collapsed groups of elements; and
selectively readjust a layout of the plurality of elements and the one or more collapsed groups of elements; and
a user interface configured to display the workflow, the workflow including a plurality of elements.

14. The system of claim 13, further comprising a database configured to store data associated with the workflow.

15. The system of claim 13, wherein the processor is further configured to:
receive a request to add a further element to the workflow;
add the further element to the workflow; and
selectively readjust the layout of the workflow.

16. The system of claim 13, wherein the processor is further configured to:
receive a request to remove a further element from the workflow;
remove the further element from the workflow; and
selectively readjust the layout of the workflow.

17. The system of claim 13, wherein the processor is further configured to:
receive a request to modify a further element of the workflow;
modify the further element of the workflow; and
selectively readjust the layout of the workflow.

18. The system of claim 13, wherein the one or more collapsible groups of elements include one or more of a loop, a conditional statement, a computational tool, a marker, an algorithm, and a nested workflow.

19. The system of claim 13, wherein the plurality of elements comprises one or more of a word, an idea, and a task.

20. The system of claim 13, wherein the processor is further configured to add a space saving element to the layout of the workflow.

21. The system of claim 13, wherein the processor is further configured to:
receive a request to create a visualization of an element or a group of elements of the workflow, the visualization allowing the user to edit the element or the group of elements while working on the workflow; and
create the visualization of the element or the group of elements of the workflow.

22. The system of claim 21, wherein the visualization comprises an inline editor.

23. The system of any one of claims 13 through 22, wherein the multimode compute cluster is Hadoop-based.

24. The system of any one of claims 13 through 23, wherein the workflow is a scientific workflow.

25. The system of claim 24, wherein the scientific workflow is a bioinformatics workflow analyzing very large genomic data sets.

26. A non-transitory computer-readable storage medium having embodied thereon a program, the program being executable by a processor to perform a method for visualization of elements of a workflow that defines an analysis of very large data sets using multi-node compute clusters, the method comprising:
display, via a user interface, the workflow, the workflow including a plurality of elements;
define within the workflow, based on predetermined grouping criteria, one or more collapsible groups of elements;
receive, from a user, a request to collapse the one or more collapsible groups of elements;
collapse the one or more collapsible groups of elements into one or more collapsed groups of elements;
selectively readjust a layout of the plurality of elements and the one or more collapsed groups of elements;
receive a request to add a further element to the workflow;
add the further element to the workflow;
receive a request to remove a further element from the workflow;
remove the further element from the workflow;
receive a request to modify a further element of the workflow;
modify the further element of the workflow;
selectively readjust the layout of the workflow;
add a space saving element to the layout of the workflow;
receive a request to create a visualization of an element or a group of elements of the workflow, the visualization allowing the user to edit the element or the group of elements while working on the workflow; and
create the visualization of the element or the group of elements of the workflow.

27. A distribution platform for a workflow that defines an analysis of very large data sets using multi-node compute clusters comprising:
a user interface configured to allow a user to select a workflow based on one or more parameters associated with the workflow;
a distribution module configured to enable:
a user to acquire the workflow; and
importing the workflow into a user environment; and
a management engine for workflows configured to support development of the workflow imported into the user environment.

28. The platform of claim 27, wherein the user interface is configured to provide one or more of the following functionalities: searching for the workflow, viewing information associated with the workflow, purchasing the workflow, downloading the workflow to a user device, and enabling a developer to develop a tool and upload the tool to the management engine for workflows.

29. The platform of claim 27, wherein the workflow is provided via an application installed on a user device or via a web-based application.

30. The platform of claim 27, wherein the user interface is regulated by a platform operator, each workflow requiring an approval process and compliance with predetermined guidelines.

31. The platform of claim 27, wherein parameters and tools associated with the workflow are editable after the workflow is imported into the user environment.

32. The platform of claim 27, wherein the workflow is editable after being imported into the user environment.

33. The platform of claim 27, wherein the distribution module allows assessing fees from a workflow acquirer.

34. The platform of claim 33, wherein a percentage of the fees is paid to a platform operator.

35. The platform of claim 27, wherein the workflow is sold on a basis selected from one or more of the following: a unlimited usage for a defined period of time, a per-use basis, and a one-time lump sum basis for unlimited use.

36. The platform of claim 27, wherein the workflow is distributed as software as a service (SaaS).

37. The system of any one of claims 27 through 36, wherein the multimode compute cluster is Hadoop-based.

38. The system of any one of claims 27 through 37, wherein the workflow is a scientific workflow.

39. The system of claim 38, wherein the scientific workflow is a bioinformatics workflow analyzing very large genomic data sets.

40. A computer-implemented method for distributing a workflow that defines an analysis of very large data sets using multi-node compute clusters comprising:
receiving, by a user interface, a user command to select a workflow based on one or more parameters associated with the workflow;
enabling a user to acquire the workflow;
enabling the user to import the workflow into a user environment; and
supporting, by a management engine for workflows, development of the workflow imported into the user environment.

41. The method of claim 40, wherein the user interface is configured to provide one or more of the following functionalities: searching for the workflow, viewing information associated with the workflow, purchasing the workflow, downloading the workflow to a user device, and enabling a developer to develop a tool and upload the tool to the management engine for workflows.

42. The method of claim 40, wherein the workflow is provided via an application installed on a user device or via a web-based application.

43. The method of claim 40, wherein the user interface is regulated by a platform operator, each workflow requiring an approval process and compliance with predetermined guidelines.

44. The method of claim 40, wherein parameters and tools associated with the workflow are editable after the workflow is imported to the user environment.

45. The method of claim 40, wherein the workflow is sold on a basis selected from one or more of the following: unlimited usage for a defined period of time, a per-use basis, and a one-time lump sum basis for unlimited use.

46. The method of claim 40, wherein the workflow is distributed as software as a service (SaaS).

47. The method of any one of claims 40 through 46, wherein the multimode compute cluster is Hadoop-based.

48. The method of any one of claims 40 through 47, wherein the workflow is a scientific workflow.

49. The method of claim 48, wherein the scientific workflow is a bioinformatics workflow analyzing very large genomic data sets.

50. A non-transitory computer-readable medium comprising instructions, which when executed by one or more processors, perform the following operations:
receive, by a user interface, a user command to select a workflow that defines an analysis of very large data sets using multi-node compute clusters based on one or more parameters associated with the workflow;
enable a user to acquire the workflow, enable the user to import the workflow into a user environment; and
support, by a management engine for workflows, development of the workflow imported into the user environment.

51. An event-driven management engine for workflows that define an analysis of very large data sets using multi-node compute clusters comprising:
a decision node configured to:
determine that at least one condition is true, wherein the determination that the at least one condition is true comprises running a conditional loop configured to check whether the at least one condition is true; and
based on the determination, selectively activate at least one computational module;
a fork join queuing cluster configured to:
allocate the at least one computational module non-sequentially to participant computational nodes in a distributed cloud computing environment; and
process a data set according to predetermined criteria; and
a distributed database configured to:
store the at least one computational module; and
store the at least one condition associated with the at least one computational module, wherein the at least one computation module is not activated until the at least one condition is true.

52. The engine of claim 51, wherein the allocating of the at least one computational module non-sequentially to participant computational nodes comprises dividing tasks associated with the computational module into a plurality of fragments, each fragment being processed on a participant computational node.

53. The engine of claim 52, wherein the at least one computational module is configured to use one or more fork join queuing clusters configured to divide the tasks for service by the participant computational nodes and join processed fragments after processing by the participant computational nodes.

54. The engine of claim 51, wherein the allocating of the at least one computational module non-sequentially to the participant computational nodes comprises joining processed fragments into a processed data set.

55. The engine of claim 51, wherein the fork-join queuing cluster includes a master node and participant computational nodes, wherein the master node is configured to receive tasks associated with the computational module, divide the tasks into a plurality of fragments, and distribute fragments to participant computational nodes; and wherein the participant computational nodes are configured to process the fragments and send processed fragments to the master node.

56. The engine of claim 55, wherein the master node is further configured to collect the processed fragments from the participant computational nodes and join the processed fragments into a processed data set.

57. The engine of claim 51, where the cloud computing environment includes a plurality of computational clusters to increase performance and enable parallel execution of tasks.

58. The engine of claim 51, wherein the computational module comprises a bioinformatics tool.

59. The engine of claim 51, further comprising: a user interface to allow a user to build computational modules, modify computational modules, specify data sources, and specify conditions for execution of the computational modules.

60. The engine of claim 51, wherein the workflow supports a plurality of biological data formats and translations between the plurality of biological data formats.

61. The engine of any one of claims 51 through 60, wherein the multimode compute cluster is Hadoop-based.

62. The engine of any one of claims 51 through 61, wherein the workflow is a scientific workflow.

63. The engine of claim 62, wherein the scientific workflow is a bioinformatics workflow analyzing very large genomic data sets.

64. A computer-implemented event-driven management method for workflows that define an analysis of very large data sets using multi-node compute clusters comprising:
storing, by a distributed database, at least one computational module;
storing, by the distributed database, at least one condition associated with the at least one computational module, wherein the at least one computation module is not activated until the at least one condition is true;
determining, by a decision node, that the at least one condition is true, wherein the determination that the at least one condition is true comprises running a conditional loop configured to check whether the at least one condition is true;
based on the determination, selectively activating, by the decision node, the at least one computational module; and
allocating, by a fork join queuing cluster, the at least one computational module non-sequentially to participant computational nodes in a distributed cloud computing environment, wherein the at least one computational module is configured to process a data set according to predetermined criteria.

65. The method of claim 64, wherein the allocating of the at least one computational module non-sequentially to the participant computational nodes comprises dividing tasks associated with the computational module into a plurality of fragments, each fragment being processed on a participant computational node.

66. The method of claim 65, wherein the computational module is configured to use one or more fork-join queuing clusters configured to divide the tasks for service by the participant computational nodes and join processed fragments after processing by the participant computational nodes.

67. The method of claim 66, wherein each of the one or more fork join queuing clusters includes a master node and participant computational nodes, wherein the master node is configured to receive tasks associated with the computational module, divide the tasks into a plurality of fragments, and distribute fragments to participant computational nodes; and wherein the participant computational nodes are configured to process the fragments and send processed fragments to the master node.

68. The method of claim 64, wherein the allocating of the at least one computational module non-sequentially to the participant computational nodes comprises joining processed fragments into a processed data set.

69. The method of claim 64, where the cloud computing environment includes a plurality of computational clusters to increase performance and enable parallel execution of the tasks.

70. The method of claim 64, wherein the computational module comprises a bioinformatics tool.

71. The method of claim 64, further comprising providing a user interface to allow a user to build computational modules, modify computational modules, specify data sources, and specify conditions for execution of the computational modules.

72. The method of claim 64, wherein the workflow supports a plurality of biological data formats and translations between the plurality of biological data formats.

73. The method of any one of claims 64 through 72, wherein the multimode compute cluster is Hadoop-based.

74. The method of any one of claims 64 through 73, wherein the workflow is a scientific workflow.

75. The method of claim 74, wherein the scientific workflow is a bioinformatics workflow analyzing very large genomic data sets.

76. A non-transitory computer-readable medium comprising instructions, which when executed by one or more processors, perform the following operations:
store, by a distributed database, at least one computational module;
store, by the distributed database, at least one condition associated with the at least one computational module, wherein the at least one computation module is not activated until the at least one condition is true;
determine, by a decision node, that the at least one condition is true, wherein the determination that the at least one condition is true comprises running a conditional loop configured to check whether the at least one condition is true;
based on the determination, selectively activate, by the decision node, the at least one computational module; and
allocate, by a fork-join queuing cluster, the at least one computational module non-sequentially to participant computational nodes in a distributed cloud computing environment, wherein the at least one computational module is configured to process a data set according to predetermined criteria.
